(19) United States
(12) Patent Application Publication
(10) Pub. No.: US 2004/0136570 A1
(43) Pub. Date: Jul. 15, 2004

(54) Method and apparatus for image enhancement for the visually impaired

(76) Inventors: Shimon Ullman, Rehovot (IL); Dror Zur, Herzlia (IL)

Correspondence Address: Martin Fleit, Fleit Kain Gibbons Gutman Bongini & Bianco, Suite 404, 601 Brickell Key Drive, Miami, FL, 33131, US

(21) Appl. No.: 10/473,780

(22) PCT Filed: Apr. 30, 2002
(86) PCT No.: PCT/US02/13548

(51) Int. Cl. G06K 9/00

(52) U.S. Cl. 382/114

(57) ABSTRACT

A method and apparatus providing good image enhancement for the visually impaired utilizing the “Ullman-Zur enhancement” algorithm. The method and apparatus consists in obtaining an original image, detecting and enhancing the edges and lines of the image by using Balanced Difference of Gaussians to obtain a first processed image, smoothing the original image by using a convolution of the original image with Gaussian, enhancing the contrast of the smoothed image, calculating the intensity average, AC, and the standard deviation of the intensity, SDC, of the chosen region, and stretching the intensity of the smoothed image linearly according to AC, SDC, and some specific rules to obtain a second processed enhanced image. The first processed image is superimposed on the second processed enhanced image to obtain the final enhanced image that is more readily perceived by a visually impaired person.

### BACKGROUND OF THE INVENTION

1. Field of Invention

The present invention relates to a method for enhancing still and video images for the visually impaired, and more particularly, relates to an apparatus and method for testing, evaluating and reducing, the perceptual effects of people with visual disorders like Age-related Macular Degeneration (AMD).

2. Prior Art

Early stage damage to the visual system arises primarily from damage to the retina arising from a disease or an accident. We will deal primarily with conditions resulting in damaged localized regions (called ‘scotoma’ and in plural ‘scotomata’ or ‘scotomas’) in the retina. An example for such damaged retina is shown in FIG. 1.

Such conditions result in an input image that is disrupted by local regions where the visual input is not available. A simulated example is shown in FIG. 2. Picture A is the original image of Albert Einstein while Picture B is the simulation of the damage image at the retina level. The simulation includes damage usually called non-geographical atrophy (the random scattered black dots) and geographical atrophy (the black spots).

The perceptual effects of the peripheral damage are very different in nature, however, from the discontinuous image like the one in FIG. 2. Perceptually, the image usually appears continuous and at the same time distorted and blurred in certain ways. FIG. 3 shows an example of the damaged retina appears in the top view of picture A together with its visual field mapping, see bottom view of picture A. The field mapping shows regions (marked by ‘o’) where light stimuli are perceived by the observer, and regions (marked by ‘x’) where light stimuli are not perceived.

The pictures B and C of FIG. 3 shows two examples of shapes (top) and the perception, as described by the patient (bottom). As will be evident from the pictures B and C of FIG. 3, the perceived shapes are distorted and blurred, but without interruption.

It is convenient to discriminate in the visually impaired population between blinds and people with low vision. The low vision individuals still see but their sight has been damaged by a disease or an accident, in a way that interferes with their normal functionality, and cannot be corrected by common optical aids such glasses or lenses. In most cases, this damage is in the retina. The majority of the visually impaired are the low vision people. For example, in the U.S. the approximate numbers vary between 6 to 15 millions visually impaired, out of which only 100,000 are truly blind [1][2][3]. It is clear from these numbers that helping the low vision population could have a large impact. Since medical treatment in these cases is usually limited, it is of interest to explore the possible use of computer vision aids.

There are many types of visual impairments, that differ in the damage to the tissues and in its causes. Most of the visual defects are caused by early stage damage to the retina, although there are some defects caused by damage to the optical nerve or to the visual cortex. Among the retinal diseases the AMD (Age Related Macular Degeneration) is the most common [4][5][6][7]. This disease gradually ruins the functionality of the photoreceptors in the center of the retina (the macula), and damages the central field of sharp vision normally used for recognition and detection of details and objects. It can appear in two types: the “dry” type, caused by the degeneration of the cells in the retina, and the “wet” type, caused by uncontrolled growth of new blood vessels, and the leakage of blood damaging the retina cells. Both types are related to aging, and most of the patients are over 65 [8]. For example, in the Chesapeake Bay Watermen ophthalmologic study [9], which included more than 250 participants, it appeared that 7% of the population between 50-59 had AMD at its starting phase, compared with 14% of the population between 60-69 and 26% of the population over 70.

Nowadays, there is an increased public awareness especially in the U.S., for the great difficulties that people with impaired vision encounter, and a tendency of allocating resources for research, development and public aids installation has started. For example, signs that talk in the presence of the visually impaired and headphones in which a movie is described in detail are already installed in some cities of California. In the computer domain there is a continuous effort to develop effective tactile or audio devices for input/output. However, it seems that the breakthrough in the domain of aids for the visually impaired has yet to occur.

Several types of visual aids are used to help the visually impaired. Most of these aids use relatively simple techniques of magnifying the image, enhancing the light intensity and improving the brightness and the color contrast, in order to facilitate the extraction of the visual information by the low vision observer.

The magnification of the image increases the retinal area to which a specific element of the image is projected, and therefore increases the probability that more intact photoreceptors will be covered. Although this is the most prevalent method today, it achieves limited improvement, and at same time it reduces the general amount of visual information perceived. The enhancement of contrast and light intensity is intended to compensate for the decrease in the retinal sensitivity. Some examples of the current equipment are listed in table 1.

TABLE 1
Visual aids for the low vision people

| Apparatus Name | Description |
|---|---|
| Telescope glasses | Enable Optical magnification (*16 and more) and |
| | separate fixation in each eye. |
| CCTV (Close | A video image magnification (*60 and more) tool |
| Circuit TV) | including 20 different combinations of background |
| | and foreground colors (intended especially for binary |
| | image such as printed paper). |
| Magnification | Enables magnification of a display and scanning of |
| software | the screen using a sequence of magnified images. |
| LVES | A portable apparatus including helmet with a camera |
| (Low Vision | and a screen, and a processing unit. The apparatus |
| Enhanced | enables image magnification and control of the |
| System) | fixation, intensity level and contrast level [1]. |

In the framework of a future version of the Low Vision Enhanced System (LVES), it is planned to develop an experimental method of projecting the image only to the relatively intact areas of the retina. However, it still unclear if it can be implemented practically, and if the low vision patients will reasonably perceive integrated visual information when using this method. Another approach being studied is implantation of an electrical chip that will stimulate the intact retinal cells [10][11][12]. Two develop projects are on going, the Artificial Silicon Retina (ASR) of Optobionics Corporation, and the multiple-unit artificial retina chipset (MARC) being developed at the NCSU-ECE [13]. However, these projects are yet impractical, and require an extensive clinical and neuro-anatomic research. Since the optical devices have limited effect, and since the neuro-anatomic and the clinical domain are far from being practical, the new generation of computerized image-processing device becomes attractive. The commercial CCTV and LVES start to implement this direction, but they use common and standard algorithms, which were mostly used before for normal vision enhancement. An new approach designed for the visually impaired, which tries to enhance the contrast, and the line and edges of the image, was presented lately at The Schepens Eye Research Institute. The contrast enhancement algorithm [14] seems to stand for the online requirement of the video images, but its simplification seems to damage the effectiveness for the visually impaired. On the other hand, the Hilbert transformation algorithm [15], and the frequency filter algorithm [16] seems to be more effective for the visually impaired, but they seem to exceed the online limitations of video images. Accordingly, a need still exists for the development of a method and apparatus for image enhancement for the visually impaired.

### SUMMARY OF THE INVENTION

According to the present invention, a novel method and apparatus is presented that will provide good image enhancement for the visually impaired utilizing a novel algorithm approach. This is accomplished by the development and use of a novel algorithm in the method and apparatus of the invention, the “Ullman-Zur enhancement” algorithm, that comprises, the steps of obtaining an original image, detecting and enhancing the edges and lines of the image by using Balanced Difference of Gaussians to obtain a first processed image, smoothing the original image by using a convolution of the original image with Gaussian, enhancing the contrast of the smoothed image, calculating the intensity average, AC, and the standard deviation of the intensity, SDC, of the chosen region, and stretching the intensity of the smoothed image linearly according to AC, SDC, and some specific rules to obtain a second processed enhanced image, superposing the first processed image on the second processed enhanced image to obtain the final enhanced image. The result is a final enhanced image that is more readily perceived by a visually impaired person. In the final enhanced image the line and edge density is reduced (although locally it may be increased in specific regions), the prominent edges and lines have better contrast while the negligible edges and lines are smoothed out.

In a further development, the invention makes use of the algorithms that include the change of density, regularity, and contrast according to prominence and negligibility, of dots and textural patterns. Lines and texture may be replaced by lines or texture patterns which are denser, more regular, or have higher contrast. In general, the proposed enhancement algorithm is utilizing a normal visual effect, the filling-in [17][18][19][20][21][22][23][24][25], which extensively appears in AMD patients. The filling-in enables the brain to complete missing information in specific regions, occluded regions for example, according to the context of the surroundings. In AMD patients the filling-in enables to complete the scotoma regions according to the surroundings.

The inventive apparatus and method enables the cortex of AMD patient to better understand the context of the surroundings and to complete the scotoma region accordingly. The described method fits well general and natural images, but a specific interest is giving to images of characters (text). Characters are synthetic features and their importance comes from the significance of the reading activity for the elderly daily life. In case of characters, the characters and words (group of adjacent characters) are detected by common and efficient OCR algorithm, then the characters are replaced by characters with the best font type and size, an extra apace is entered between the characters and words, the best brightness and color contrast is applied to the characters and the background, and only then the “Ullman-Zur enhancement” algorithm is applied to add an artificial enhancement, which enables better filling-in of the characters by AMD patients. Later version of the algorithm will include the replacement of and change of shape, size, density and regularity of image features of various types. The replacement and change may be performed according to templates of the feature. Template is an instance of a specific feature, stored and pre-tested in advance to achieve optimal perception of the feature. For example, specific objects, such as the mouth and nose of the face, may be replaced with similar templates which are best filled-in. In addition, the regularity and density of features might be manipulated. Adjacent lines might be added to the edges of detected characters (in similar way to the result of applying the Ullman-Zur algorithm” on a characters image) to induce high contrast between the characters and the adjacent lines while the background has intermediate intensity.

The inventive apparatus and method will have real-time implementation for TV video images, camera still and video images, and computer images. The invention includes evaluation methods, the size, contrast, and simulation tests, to estimate in an objective and quantitative way, the efficiency of the enhancement algorithm. In addition, it includes a damage severity measurement, to measure the patient's actual damage, after the filling-in compensation, in order to estimate in advance the amount of requested enhancement. Various combinations, adjustments and improvements of the invention will become more evident as the specification proceeds.

The described above invention comes in addition and in combination with the common methods used for the visually impaired, which are described in the prior art section, such as magnification and contrast enhancement.

The invention is directed to a method for enhancing an image for a visually impaired person, comprising the steps of determining at least one discrete feature of an image, and modifying the determined feature to alter its appearance to a visually impaired person. The method can further include the step of at least one of magnification of the image, contrast enhancement of the whole image, contrast enhancement of local frequency range of the image and contrast enhancement of local spatial range of the image. Also, the method include the step of at least one of adding, removing, enhancing and diminishing of the determined feature. The image can be obtained from a video stream. Also, the modification can occur offline before the image is presented, or in real-time while the images are presented. In addition, the modification can be controlled in real-time by a human observer of the image.

Besides the foregoing, the invention contemplates that the step of modifying the determined feature can include the step of changing the spatial density in the image, changing the spatial regularity of the image or changing the size and shape of the image. The feature being modified can be replaced in the image with a template of the same type. Further, modifying the determined feature can include the step of changing selectively part of the feature of the image according to predefined rules.

The inventive method can be for enhancing an image for a visually impaired person, and can comprise the step of modifying discrete features of the image to alter their appearance to a visually impaired person. As the method is practiced, it can include the steps enhancing selectively part of the features of the image according to predefined rules, and diminishing the rest of the image. Also, the novel method can include the step of spatially smoothing the background, and contracting the background to intermediate intensities, or the background can be stretched to a bounded range of intensities.

The invention is essentially directed to a novel method of enhancing an image comprise the steps of determining relevant discrete lines and discrete edges in the image, and enhancing the determined lines and images. The enhancement can occur by replacing each relevant line or edge by a combination of a line adjacent to an edge, by replacing each relevant line and edge by a patch of line grating, by replacing each relevant line and edge by a Gabor patch, or by replacing each relevant line and edge by two adjacent lines, one bright and one dark, and the bright line can be located at the brighter side of the background surrounding the two lines, and the dark line can be located at the darker side of the background surrounding the two lines. Also, the intensity of the lines can be stretched to extreme values.

The novel method for enhancement can be practiced with respect to relevant lines and texture patterns in the image. The relevant lines and texture patterns in the image are enhanced by making them spatially denser, by making them more spatially regular or by stretching the intensity of the lines and texture elements to extreme values.

The invention has special applicability to a method for enhancing an image comprising the steps of detecting characters in an image, and enhancing the detected characters. Lines and characters in the image can be enhanced by modifying their size, by modifying line attributes and fonts of the characters, by modifying the space between lines and between characters, by modifying the space between lines, between characters, and between words and/or by modifying contrast of the lines, characters and their background.

In a particular manifestation of the invention, the method as applied to characters, can include a step wherein a line grating is added adjacent to lines and to edges of the characters and/or a Gabor patch is added adjacent to lines and to edges of the characters. Also, according to the invention, when a line is added adjacent to existing lines, and to edges of the characters, the intensity of the characters and their adjacent lines have extreme values in an opposed way, and the background of the characters with the adjacent lines have intermediate intensity value. Further, when a line is added adjacent to existing lines, and to edges of characters, the characters and the adjacent lines have high color contrast, and their background having intermediate color contrast.

One aspect of the method enables the changed features to be reduced by spatial filtering, by temporally continuous filtering, by temporal filtering and/or by spatially oriented filtering.

The image enhancement method of the present invention for enhancing relevant features of an image comprises the following steps:

a. capturing the intensity channel of the image;

b. detecting and signing the relevant features in the intensity channel of the image;

c. changing discrete relevant features in the intensity channel of the image; and

d. compensating the rest of the channels for the change.

The invention also contemplates an image enhancement method comprising the steps of:

a. capturing the intensity channel of the image;

b. detecting and signing the relevant features in the intensity channel of the image;

c. smoothing the original image;

d. contracting or stretching the intensity channel of the smoothed image between predefined intensity limits;

e. compensating the rest of the channels for the contraction or stretching;

f. changing the relevant features in the intensity channel of the contrast contracted or stretched and smoothed image; and

g. compensating the rest of the channels for the change;

whereby relevant features of the image are enhanced and background of an image diminished.

The aforesaid image enhancement method can include in step f, superimposing substituting features for the relevant edges and lines on the intensity channel of the contrast contracted (or stretched) and smoothed image. Further step f can include making relevant lines and texture patterns denser and more regular in the intensity channel of the contrast contracted (or stretched) and smoothed image.

In a more specific elaboration, the present invention is directed to an image enhancement method that substitutes relevant edges and lines with two adjacent lines and diminishes the background of the image comprising the following steps:

a. capturing the intensity channel I₀ (x, y) of the image Im₀ (x, y);

b. signing the relevant edges and lines by convoluting the intensity channel of the original image with Difference of Gaussian (DOG):

I₁=(G₉₄ _{₀}−α·G_{β·σ}_{₀})*I₀

Where G_{σ} (x, y) is a Gaussian function with zero average and σ Standard deviation,

$${G}_{σ} ( x , y ) = \frac{1}{2 Π {σ}^{2}} {ⅇ}^{\frac{{x}^{2} + {y}^{2}}{2 {σ}^{2}}}$$

α is the balance ratio and β is the space ratio;

c. smoothing all the channels of the original image by convoluting it with an average operator, such as a gaussian smoother:

Im₂=G_{σ}_{₁}*Im₀;

d. contracting (or stretching) the contrast of the intensity channel of the smoothed image between predefined limits, by using percentage enhancement:

$$\{ \begin{matrix}if {K}_{1} < {I}_{2} ( x , y ) < {K}_{2} then \\ {I}_{3} ( x , y ) = ( {I}_{2} ( x , y ) - {K}_{1} ) \cdot \frac{{M}_{2} - {M}_{1}}{{K}_{2} - {K}_{1}} + {M}_{1} \\ else if {I}_{2} ( x , y ) \geq {K}_{2} then \\ {I}_{3} ( x , y ) = {M}_{2} \\ else \\ {I}_{3} ( x , y ) = {M}_{1}\end{matrix}$$

where K₁ and K₂ are lower and upper limits, appropriately, in the intensity channel of the smoothed image, and M₁ and M₂ are lower and upper limits, appropriately, in the intensity channel of the contracted (stretched) image;

e. compensating the rest of the channels of Im₃ (x, y) for the contraction (or stretching);

f. superimposing the two adjacent lines on the relevant edges and lines in the intensity channel of the contrast contracted (stretched) and smoothed image by using the following rule:

$$\{ \begin{matrix}if {I}_{1} ( x , y ) \geq A then \\ {I}_{4} ( x , y ) = 0 \\ else if {I}_{1} ( x , y ) \leq B then \\ {I}_{4} ( x , y ) = 255 \\ else \\ {I}_{4} ( x , y ) = {I}_{3} ( x , y )\end{matrix}$$

where A and B are the upper and lower thresholds; and

g. compensating the rest of the channels of Im₄ (x, y) for the superimposition (f).

A further specific elaboration of the present invention is an image enhancement method that substitutes relevant edges and lines with two adjacent lines and diminishes the background of an image by using HSV and RGB color image formats comprising the following steps:

a. capturing the intensity channel V₀ (x, y)=max(R₀, G₀, B₀) of the image Im₀ (x, y);

b. signing the relevant edges and lines by convoluting the intensity channel of the original image with Difference of Gaussian (DOG):

V₁=(G_{σ}_{₀}−α·G_{β·σ}_{₀})*V₀

where G_{σ} (x, y) is a Gaussian function with zero average and σ Standard deviation,

$${G}_{σ} ( x , y ) = \frac{1}{2 Π {σ}^{2}} {ⅇ}^{\frac{{x}^{2} + {y}^{2}}{2 {σ}^{2}}}$$

α is the balance ratio and β is the space ratio;

c. smoothing all the channels of the original image (R₀,G₀,B₀) by convoluting it with an average operator, such as a gaussian smoother:

Im₂=G_{σ}_{₁}*Im₀;

d. contracting (or stretching) the contrast of the intensity channel of the smoothed image V₂=max(R₂, G₂, B₂) between predefined limits, by using percentage enhancement:

$$\{ \begin{matrix}if {K}_{1} < {V}_{2} ( x , y ) < {K}_{2} then \\ {V}_{3} ( x , y ) = ( {V}_{2} ( x , y ) - {K}_{1} ) \cdot \frac{{M}_{2} - {M}_{1}}{{K}_{2} - {K}_{1}} + {M}_{1} \\ else if {V}_{2} ( x , y ) \geq {K}_{2} then \\ {V}_{3} ( x , y ) = {M}_{2} \\ else \\ {V}_{3} ( x , y ) = {M}_{1}\end{matrix}$$

where K₁ and K₂ are lower and upper limits, appropriately, in the intensity channel of the smoothed image, and M₁ and M₂ are lower and upper limits in the intensity channel of the contracted (stretched) image;

e. compensating the rest of the channels of Im₃ (x, y) for the contraction (or stretching) by keeping the relations

$$\frac{{R}_{3}}{{G}_{3}} = \frac{{R}_{2}}{{G}_{2}} , \frac{{G}_{3}}{{B}_{3}} = \frac{{G}_{2}}{{B}_{2}} ;$$

f. superimposing the two adjacent lines on relevant edges and lines in the intensity channel of the contrast contracted (stretched) and smoothed image by using the following rule:

$$\{ \begin{matrix}if {V}_{1} ( x , y ) \geq A then \\ {V}_{4} ( x , y ) = 0 \\ else if {V}_{1} ( x , y ) \leq B then \\ {V}_{4} ( x , y ) = 255 \\ else \\ {V}_{4} ( x , y ) = {V}_{3} ( x , y )\end{matrix}$$

where A and B are the upper and lower thresholds; and

g.) compensating the rest of the channels of Im₄ (x, y) for the superimposition by keeping the relations

$$\frac{{R}_{4}}{{G}_{4}} = \frac{{R}_{3}}{{G}_{3}} , \frac{{G}_{4}}{{B}_{4}} = \frac{{G}_{3}}{{B}_{3}} .$$

In the specific elaborations given above, the smoothness level of the background can be controlled in offline or controlled in real-time. Likewise, the contraction (or stretching) level of the background can be controlled in offline or controlled in real-time. Also, the density of the enhancing lines can be controlled in offline or controlled in real-time. Still further, width of enhancing lines can be controlled in offline or controlled in real-time. In like fashion, regularity of enhanced texture is controlled in offline or controlled in real-time. Also, density of enhanced texture is controlled in offline or controlled in real-time.

In a still further specific elaboration of the present invention the method can include the aspect of substituting relevant edges and lines with two adjacent lines and diminishing background of an image, in which the smoothness of the background is controlled by the width of the Gaussian

G_{σ}_{₁}. Alternatively, the substitution of the relevant edges and lines with two adjacent lines and diminishing the background, can be effected by the contraction (or stretching) level of the background, controlled by the lower and upper limits values K₁, K₂, M₁, M₂.

Further aspects of the method contemplate substituting the relevant edges and lines with two adjacent lines and diminishing the background, in which the density and the width of the enhancing lines is controlled by the parameters of the DOG, G_{σ}_{₀}−α·G_{β·σ}_{₀}, and the thresholds values A and B, and/or substituting the relevant edges and lines with two adjacent lines and diminishing the background, in which the two-dimensional convolutions are implemented by an equivalent successive one-dimensional convolutions. Alternatively, the method may be carried out with substituting the relevant edges and lines with two adjacent lines and diminishing the background, in which the two-dimensional convolutions are implemented by equivalent FFT transformations.

The invention further is directed to a character image enhancement method, comprising the following steps:

a. manipulating the lines and characters in the image, and

b. applying an image enhancement method according to claim 45 on the manipulated image to enhance discrete lines and characters in the image.

The invention as it relates to characters may proceed wherein the lines and characters in the image are manipulated by using the following steps:

a. capturing the intensity channel of the image;

b. detecting and signing the lines and characters in the intensity channel of the image by using an Optical Characters Recognition (OCR) or threshold algorithm;

c. changing the attributes of the lines and fonts of the characters in the intensity channel of the image;

d. changing the size of the lines and characters in the intensity channel of the image;

e. changing the space between the lines and characters in the intensity channel of the image;

f. changing the space between words in the intensity channel of the image;

g. changing the color contrast between the lines and characters and their background;

h. changing the brightness contrast between the lines and characters and their background;

i. compensating the rest of the channels for the changes.

The method for enhancing characters first manipulates the lines and characters, as noted above, and then enhances the manipulated lines and characters by the steps of:

a. capturing the intensity channel V₀ (x, y)=max(R₀, G₀, B₀) of the image Im₀(x, y);

b. signing the relevant edges and lines by convoluting the intensity channel of the original image with Difference of Gaussian (DOG):

V₁=(G_{σ}_{₀}−α·G_{β·σ}_{₀})*V₀

where G_{σ} (x, y) is a Gaussian function with zero average and σ Standard deviation,

$${G}_{σ} ( x , y ) = \frac{1}{2 Π {σ}^{2}} {ⅇ}^{\frac{{x}^{2} + {y}^{2}}{2 {σ}^{2}}}$$

α is the balance ratio and β is the space ratio;

c. smoothing all the channels of the original image (R₀,G₀,B₀) by convoluting it with an average operator, such as a gaussian smoother:

Im₂=G_{σ}_{₁}*Im₀;

d. contracting (or stretching) the contrast of the intensity channel of the smoothed image V₂=max(R₂,G₂,B₂) between predefined limits, by using percentage enhancement:

$$\{ \begin{matrix}if {K}_{1} < {V}_{2} ( x , y ) < {K}_{2} then \\ {V}_{3} ( x , y ) = ( {V}_{2} ( x , y ) - {K}_{1} ) \cdot \frac{{M}_{2} - {M}_{1}}{{K}_{2} - {K}_{1}} + {M}_{1} \\ else if {V}_{2} ( x , y ) \geq {K}_{2} then \\ {V}_{3} ( x , y ) = {M}_{2} \\ else \\ {V}_{3} ( x , y ) = {M}_{1}\end{matrix}$$

where K₁ and K₂ are lower and upper limits, appropriately, in the intensity channel of the smoothed image, and M₁ and M₂ are lower and upper limits, appropriately, in the intensity channel of the contracted (stretched) image;

e. compensating the rest of the channels of Im₃ (x, y) for the contraction (or stretching) (d) by keeping the relations

$$\frac{{R}_{3}}{{G}_{3}} = \frac{{R}_{2}}{{G}_{2}} , \frac{{G}_{3}}{{B}_{3}} = \frac{{G}_{2}}{{B}_{2}} . ;$$

f. superimposing the two adjacent lines on the relevant edges and lines in the intensity channel of the contrast contracted (stretched) and smoothed image by using the following rule:

$$\{ \begin{matrix}if {V}_{1} ( x , y ) \geq A then \\ {V}_{4} ( x , y ) = 0 \\ else if {V}_{1} ( x , y ) \leq B then \\ {V}_{4} ( x , y ) = 255 \\ else \\ {V}_{4} ( x , y ) = {V}_{3} ( x , y )\end{matrix}$$

where A and B are the upper and lower thresholds; and

g) compensating the rest of the channels of Im₄ (x, y) for the superimposition

(f) by keeping the relations

$$\{ \begin{matrix}if {V}_{1} ( x , y ) \geq A then \\ {V}_{4} ( x , y ) = 0 \\ else if {V}_{1} ( x , y ) \leq B then \\ {V}_{4} ( x , y ) = 255 \\ else \\ {V}_{4} ( x , y ) = {V}_{3} ( x , y )\end{matrix}$$

The present invention includes the combination of one or more of several tests incorporated as a follow on to the enhancement method. To this end, a size test can be included for determining the quality of results comprising the further steps of:

a. presenting the image to a visually impaired with a size, which is below the recognition or perception threshold;

b. increase the image size gradually;

c. letting the visually impaired sign when he/she first identifies the object or perceive the feature in the image; and

d. ranking the quality of the image according to the identification or the perception size.

Alternatively, included can be a contrast test for determining the quality of results comprising the further steps of:

a. presenting the image to the visually impaired with a contrast; which is below the recognition or perception threshold;

b. increasing the image contrast gradually;

c. letting the visually impaired to sign when he/she first identifies the object or perceive the feature in the image; and

d. ranking the quality of the image according to the identification or the perception contrast.

Still further, included can be a simulation test for determining the quality of results comprising the further steps of:

a. simulating damages and perceptual effects of visually impaired individual;

b. transforming an enhanced image according to the simulation;

c. transforming the original images according to the simulation;

d. ranking the quality according to comparison of the transformation results on the original and enhanced images.

Also, the invention contemplates a Psychophysical test for the damage of the visually impaired observer that uses the following steps:

a. testing the perceived uniformity of line grating with different spatial frequencies;

b. testing the perceived number of missing dots in a regular array of dots with different densities; and

c. testing the perceived uniformity of irregular array of dots with different irregularity levels.

The apparatus of the present invention includes the devices and components necessary to give effect to the algorithms disclosed as part of the invention. As contemplated by the invention, the apparatus is provided for image enhancement for visually impaired that substitutes relevant edges and lines of an image with two adjacent lines and diminishes the background of the image by utilizing an algorithm wherein

a. the intensity channel I₀ (x, y) of an image is captured Im₀ (x, y);

b. the relevant edges and lines are signed by convoluting the intensity channel of the original image with Difference of Gaussian (DOG):

I₁=(G_{σ}_{₀}−α·G_{β·σ}_{₀})*I₀

where G_{σ} (x, y) is a Gaussian function with zero average and σ Standard deviation,

$${G}_{σ} ( x , y ) = \frac{1}{2 \prod {σ}^{2}} {ⅇ}^{\frac{{x}^{2} + {y}^{2}}{2 {σ}^{2}}}$$

α is the balance ratio and β is the space ratio;

c. all the channels of the original image are smoothing by convoluting it with an average operator, such as a gaussian smoother:

Im₂=G_{σ}_{₁}*Im₀;

d. the contrast of the intensity channel of the smoothed image is contracting (or stretching) between predefined limits, by using percentage enhancement:

$$\{ \begin{matrix}if {K}_{1} < {I}_{2} ( x , y ) < {K}_{2} then \\ {I}_{3} ( x , y ) = ( {I}_{2} ( x , y ) - {K}_{1} ) \cdot \frac{{M}_{2} - {M}_{1}}{{K}_{2} - {K}_{1}} + {M}_{1} \\ else if {I}_{2} ( x , y ) \geq {K}_{2} then \\ {I}_{3} ( x , y ) = {M}_{2} \\ else \\ {I}_{3} ( x , y ) = {M}_{1}\end{matrix}$$

where K₁ and K₂ are lower and upper limits, appropriately, in the intensity channel of the smoothed image, and M₁ and M₂ are lower and upper limits, appropriately, in the intensity channel of the contracted (stretched) image;

e. the rest of the channels of Im₃ (x, y) are compensated for the contraction (or stretching);

f. the two adjacent lines on the relevant edges and lines in the intensity channel of the contrast contracted (stretched) and smoothed image are superimposed by using the following rule:

$$\{ \begin{matrix}if {I}_{1} ( x , y ) \geq A then \\ {I}_{4} ( x , y ) = 0 \\ else if {I}_{1} ( x , y ) \leq B then \\ {I}_{4} ( x , y ) = 255 \\ else \\ {I}_{4} ( x , y ) = {I}_{3} ( x , y )\end{matrix}$$

where A and B are the upper and lower thresholds; and

the rest of the channels of Im₄ (x, y) are compensated for the superimposition.

In an alternative, the invention provides apparatus for image enhancement for visually impaired that substitutes relevant edges and lines of an image with two adjacent lines and diminishes the background of an image by using HSV and RGB color image formats by utilizing an algorithm wherein

a. the intensity channel V₀ (x, y)=max(R₀,G₀,B₀) of the image. Im₀ (x, y) is captured;

b. the relevant edges and lines are signed by convoluting the intensity channel of the original image with Difference of Gaussian (DOG):

V₁=(G_{σ}_{₀}−α·G_{β·σ}_{₀})*V₀

where G_{σ} (x, y) is a Gaussian function with zero average and σ Standard deviation,

$${G}_{σ} ( x , y ) = \frac{1}{2 \prod {σ}^{2}} {ⅇ}^{\frac{{x}^{2} + {y}^{2}}{2 {σ}^{2}}}$$

α is the balance ratio and β is the space ratio;

c. all the channels of the original image (R₀,G₀,B₀) are smoothed by convoluting it with an average operator, such as a gaussian smoother:

Im₂=G_{σ}_{₁}*Im₀;

d. the contrast of the intensity channel of the smoothed image V₂=max(R₂, G₂, B₂) is contracted (or stretched) between predefined limits, by using percentage enhancement:

$$\{ \begin{matrix}if {K}_{1} < {V}_{2} ( x , y ) < {K}_{2} then \\ {V}_{3} ( x , y ) = ( {V}_{2} ( x , y ) - {K}_{1} ) \cdot \frac{{M}_{2} - {M}_{1}}{{K}_{2} - {K}_{1}} + {M}_{1} \\ else if {V}_{2} ( x , y ) \geq {K}_{2} then \\ {V}_{3} ( x , y ) = {M}_{2} \\ else \\ {V}_{3} ( x , y ) = {M}_{1}\end{matrix}$$

where K₁ and K₂ are lower and upper limits, appropriately, in the intensity channel of the smoothed image, and M₁ and M₂ are lower and upper limits in the intensity channel of the contracted (stretched) image;

e. the rest of the channels of Im₃ (x, y) are compensated for the contraction (or stretching) by keeping the relations

$$\frac{{R}_{3}}{{G}_{3}} = \frac{{R}_{2}}{{G}_{2}} , \frac{{G}_{3}}{{B}_{3}} = \frac{{G}_{2}}{{B}_{2}} ;$$

f. the two adjacent lines on relevant edges and lines in the intensity channel of the contrast contracted (stretched) and smoothed image are superimposed by using the following rule:

$$\{ \begin{matrix}if {V}_{1} ( x , y ) \geq A then \\ {V}_{4} ( x , y ) = 0 \\ else if {V}_{1} ( x , y ) \leq B then \\ {V}_{4} ( x , y ) = 255 \\ else \\ {V}_{4} ( x , y ) = {V}_{3} ( x , y )\end{matrix}$$

where A and B are the upper and lower thresholds; and

g.) the rest of the channels of Im₄ (x, y) are compensated for the superimposition by keeping the relations

$$\frac{{R}_{4}}{{G}_{4}} = \frac{{R}_{3}}{{G}_{3}} , \frac{{G}_{4}}{{B}_{4}} = \frac{{G}_{3}}{{B}_{3}} .$$

The apparatus of the invention can be constructed and arranged that the parameters of the system filters, transformation, operators, functionality, operation, and mode of operation adjustably. Also, the adjustment of the parameters can be organized to influence the output image. The apparatus can include one of the following:

a. an input tuner that receives the video images in the input format and transceives them to base band;

b. an Analog to Digital transceiver that samples the video frames;

c. a computerized processor that modifies the sampled images;

d. a digital to Analog transceiver that integrates the frames to analog video stream;

e. an output mixer that transforms the base band video stream to the desired output format; and

f. control panel (local or remote) enabling to control running of parameters of the method, and tests.

Also, the apparatus can be housed in one of:

a. a “Set top” box at the input of a TV set or a VCR (VideoCassette Recorder)—local enhancement;

b. server of a TV (Television) content provider, such as the Cables or the Satellite stations (remote enhancement);

c. a Digital TV, such as High Definition TV;

d. Digital VCR player;

e. DVD (Digital Versatile Disc) player;

f. Close Circuit TV;

g. Personal Computer (PC) card;

h. Personal Computer package;

i. PDA (Personal Digital Assistant).

j. Handheld computer;

k. Pocket PC;

l. Multimedia Player;

m. Computer card;

n. Internet server;

o. Chip set;

p. an apparatus at the input of a head mounted display.

Still further, the apparatus according to the invention can be used for:

a. Improving the visual perception of visually impaired individual.

b. Improving of Infrared images for observer with normal vision.

c. Improving of Ultrasound images for observer with normal vision.

Other and further objects and advantages of the present invention will become more readily apparent from the following detailed description of a preferred embodiment of the invention when taken with the appended drawings.

### BRIEF DESCRIPTION OF THE DRAWINGS

FIG. 1 is a schematic representation showing a damaged retina of an eye with the bright spot surrounding the dark spot in the center corresponding to the damaged region; the disk shown on the right side is the blind spot of the eye.

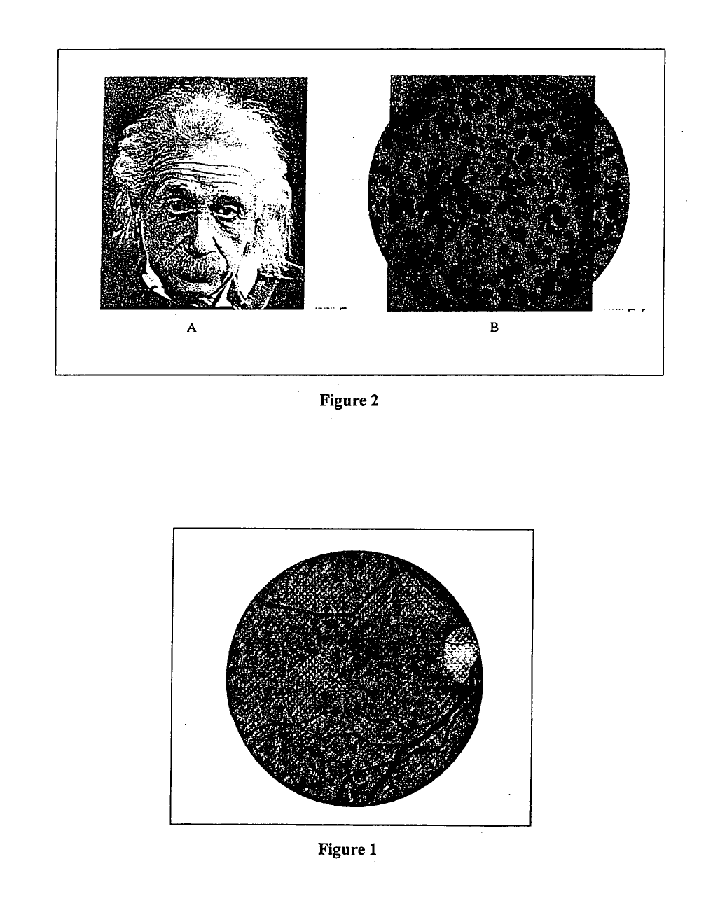

FIG. 2 includes a right view A and a left view B showing, respectively, an output image of Albert Einstein as perceived by a normal eye, view A, and the same image as perceived at the retinal level by an eye having a disrupting retinal scotomas, view B.

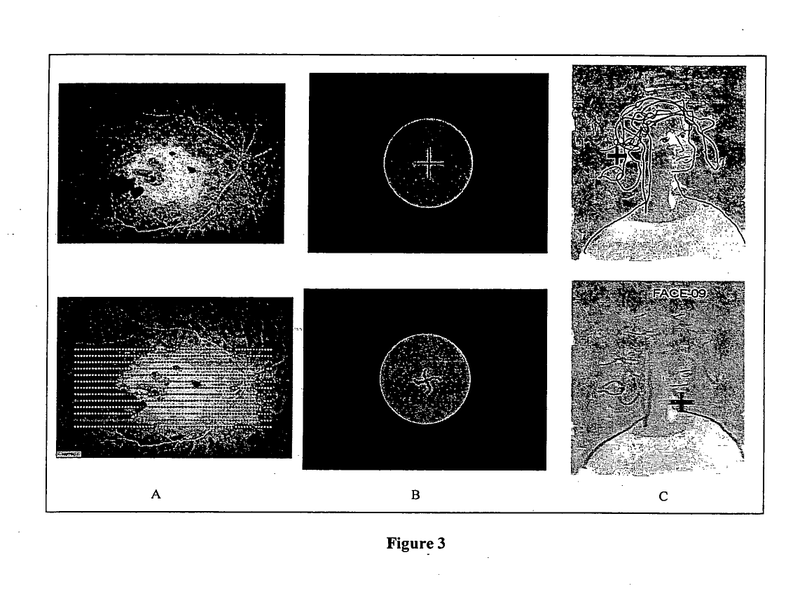

FIG. 3 shows three pictures A, B and C each having a top view and a bottom view that are examples of a photo of a damaged retina, top view A and the result of its visual field mapping shown below, bottom view A; a cross pattern, top view B, with its perception, bottom view B, shown below as reproduced by a patient with the damage shown in picture A; and a face drawing, top view C, with its perception, bottom view C, shown below as perceived by a patient with the damage shown in picture A.

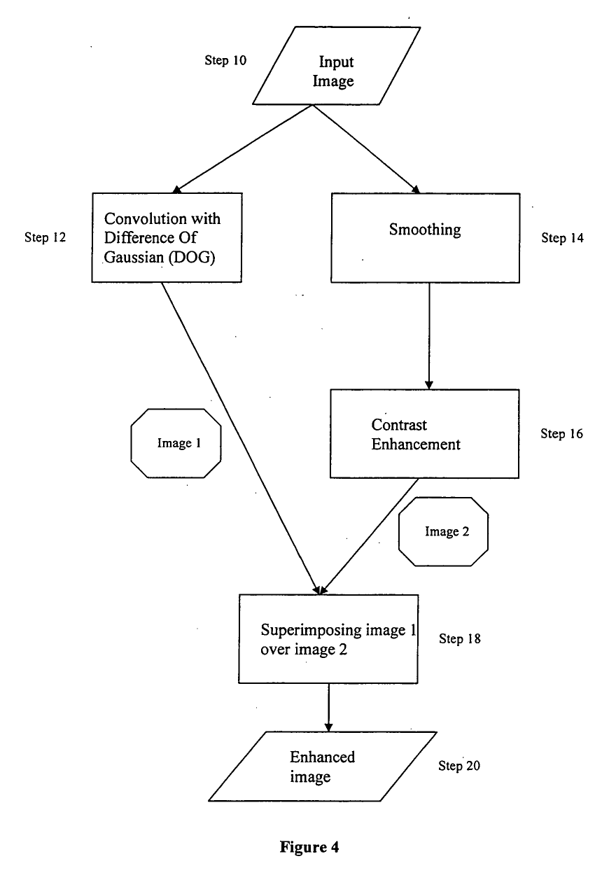

FIG. 4 is a flow chart showing the invention and more particularly, the “Ullman-Zur enhancement” algorithm of the present invention illustrating how an image is manipulated to obtain an enhanced image for presentation to a patient having a damaged retina.

FIG. 5 is a flow chart showing the pre-processing required to manipulate characters before applying the “Ullman-Zur enhancement” algorithm in order to enhance the characters image for presentation to a patient having a damaged retina.

FIG. 6 shows a series of five original images (left column) which have been enhanced, showing the algorithm results according to the teachings of the invention (middle column); in the right column the two images, the original and the enhanced images, are presented in much smaller size, a hard situation for a visually impaired person, demonstrating that the images enhanced by the practice of the present invention are clearer and more salient.

FIGS. 7A and 7B show two optional apparatus implementations incorporating the “Ullman-Zur enhancement” algorithm. In FIG. 7A an enhanced TV display is shown with the algorithm running on the set-top box (or the specific hardware) which is tuned by the Remote Control (RC). The input is either from the VCR (antenna, cables or cassette) or the CCTV camera. In FIG. 7B an enhanced PC display is shown, the algorithm running on the PC, enhancing the desktop display and the display of specific applications: Word, Media Player, CCTV, etc. In FIG. 7C portable computer (handheld) with a camera is shown, the enhanced image coming from the camera is displayed on the computer screen. In general, for each of these implementations, a head-mounted display can be connected to computer and replace the common display.

FIG. 8 shows an example of enhanced image display and a Human Machine Interface (HMI) to control it. The HMI includes control of the density of the enhanced lines, the width of the enhanced lines, and the smoothness level of the image at the background. In addition it includes a low-vision compensation level control. This comprehensive control changes the line width, density, and the image smoothness, altogether, between two useful working situations for the AMD perception. In addition the HMI includes a contrast control and a magnification control.

FIG. 9 shows the use of the adaptive filling-in simulation, based on receptive field expansion found by Gilbert and Wiesel [25], as a test for the ability of the enhanced images to reduce the AMD perceptual effects. The processed is described by the image flow from input image through retinal level image to perceived image. The adaptive filling-in transformation is described by the following formulas:

$${P}_{{i}_{0} , {j}_{0}}^{′} = \frac{1}{{\sum }_{i , j ∈ {S}_{{i}_{0} , {j}_{0}}} {g}_{i , j}^{{′i}_{0} , {j}_{0}}} \cdot {\sum }_{i , j ∈ {S}_{{i}_{0} , {j}_{0}}} {g}_{i , j}^{{′i}_{0} , {j}_{0}} \cdot {p}_{i , j}$$

$${g}_{i , j}^{{′i}_{0} , {j}_{0}} = {g}_{i , j}^{{i}_{0} , {j}_{0}} \cdot {m}_{i , j}$$

$${W}_{{i}_{0} , {j}_{0}} = min ( w ) - 1 \vert {\sum }_{i , j ∈ {S}_{{i}_{0} , {j}_{0}}^{w}} {g}_{i , j ,}^{{i}_{0} , {j}_{0}} \cdot {m}_{i , j} > 1$$

P is the input image, and P′ is the perceived image, g is a normal Gaussian function, m is the damage function (0-damage, 1-no damage), S^{W}ᵢ_{₀}^{j}_{₀} is a surroundings of the pixel (i₀, j₀) with width of w in which the Gaussian function is defined, and Wᵢ_{₀}^{,j}_{₀} is the final surroundings width of Sᵢ_{₀}^{,j}_{₀}. An extensive damage falls for example at the mouth and the left head contour of JFK. One can see that the mouth pattern and the head contour are kept better by the enhanced image.

FIG. 10 shows three examples of the functional test to measure the severity of the damage of the AMD disease, after the filling-in compensation, based on the filling-in features that were found by the invention.

### DETAILED DESCRIPTION OF PREFERRED EMBODIMENTS

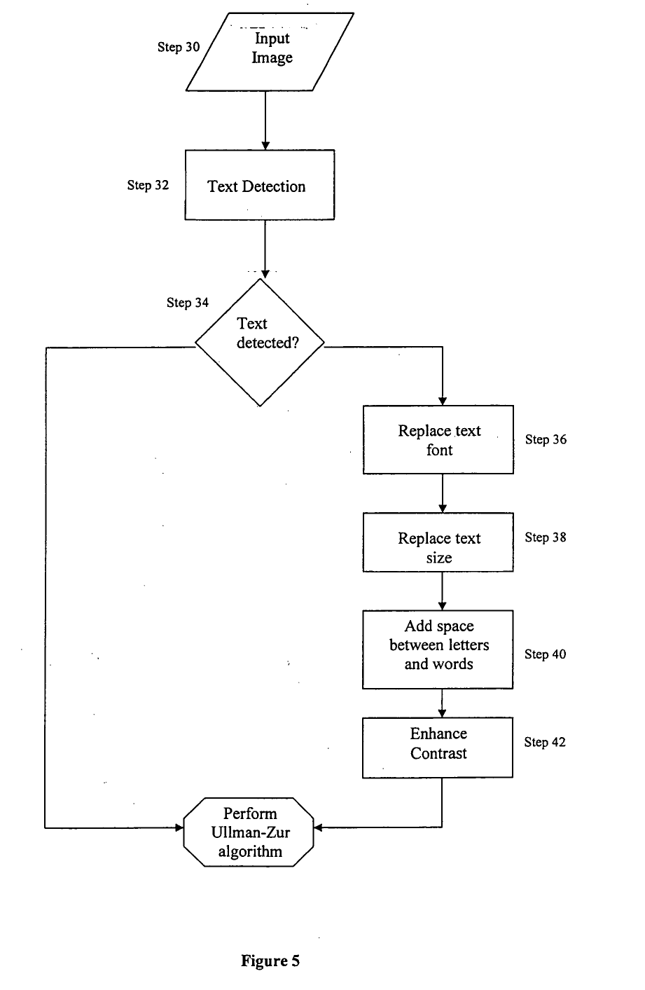

The method and apparatus of the present invention will now be described in terms of preferred embodiments in conjunction with the drawings, particular FIGS. 4-8. Essentially the method and apparatus of the present invention starts by obtaining an image, called the input image, and then, manipulates the image to enhance the input image in a way to enable a visually impaired person to see the image more clearly and more saliently. It changes the image features in a way that enables AMID patients to better perceive the surroundings of their scotomas in the sense that they can better fill-in the surroundings into the scotoma region.

The presented technique makes use of the filling-in mechanism of the AMD observer, enabling him/her to perceive the images better. For example, making the lines and edges in the image sparser and emphasizing only the relevant ones make the perception easier. On the other hand, making two dimensional texture patterns denser often enables the perception of complete pattern. In this version, the line and edge density is reduced, the prominent edges and lines have better contrast while the negligible edges and lines are smoothed out (in an improved version dots are treated in the same way).

This is accomplished as follows with reference to FIG. 4 which shows the portion of the method in flow chart form showing the main flow of the unique and novel “Ullman-Zur enhancement” algorithm. In parallel to the edge and line detection and enhancement by convolution with Balanced Difference of Gaussian (BDOG), the original image is smoothed, and contrast enhanced. Finally, the enhanced edges and lines are superimposed over the smoothed and contrast enhanced image. If the image has several intensity channels, the algorithm is preferably applied to each of the channels separately. The intensity channels are defined according to the image representation, and choosing representation with unique intensity channel has special advantages. In the initial step 10, an input image is obtained, usually in electronic form e.g., by deriving same from a television, computer, camera, or by scanning a visual image. The image is enhanced for Age-related Macular Degeneration individuals by using the inventive method that includes the “Ullman-Zur enhancement” algorithm as follows (FIG. 4):

1) Step 10, Obtaining the Intensity Channel (or Channels) of the Original Image:

Intensity channel is expressed as an intensity value associated with each pixel of the image, such as:

M≦I₀(x, y)≦N, I₀(x, y),M,N ε{R}

Where (x, y) denotes a pixel in the image, and I₀(x, y) denotes an intensity associated with that pixel. M and N are the lower and upper limits, correspondingly, of the intensity available values, and {R} denotes the set of the real numbers. For gray level images, the intensity channel should be the actual intensity value of each pixel, usually an integer value between 0 to 255. For color images, the intensity channels may be defined as each of the color channels, for example the red, green, and blue channels of the RGB representation. In the specific preferred implementation, color image is presented as HSV (Hue, Saturation, and Value for each pixel), the unique intensity channel will be the V channel, and the following algorithm will be applied with some adaptation as described later.

For its unique intensity channel (or for each of its several intensity channels separately), the image obtained and processed in Step 10 undergoes the following steps:

2) Step 12, the Image is Subjected to Edge Detection and Enhancement:

This step involves the detecting of edges and lines in the original image, and signing the locations of the detected edges and lines. The sign may reflect the prominence of the edge or the line, namely it, may enhance the edge or line according to its prominence. It has been found that the detection and enhancement, performed by convoluting the image with BDOG, has special advantages. The convolution with BDOG can be represented as

I₁=(G_{σ}_{₀}−G_{β·σ}_{₀})*I₀

where G_{σ} (x, y) is a Gaussian function with zero average and σ Standard deviation,

$${G}_{σ} ( x , y ) = \frac{1}{2 \prod {σ}^{2}} {ⅇ}^{\frac{{x}^{2} + {y}^{2}}{2 {σ}^{2}}}$$

and β is the space ratio. The value of β is recommended to be 1.6 but it can be any positive number, and the value of σ₀ is recommended to be between 2 to 6 pixels, but it might be any positive number up to third of the image width or height (the smaller of them). The output image I₁ (x, y) is the BDOG image.

3) Step 14, Smoothing the Original Image:

In parallel to the edge detection and enhancement, the original image is smoothed in Step 14. A conventional smoothing can be achieved by convoluting the original image with Gaussian:

I₂=G_{σ}_{₁}*I₀

where σ₁ is recommended (preferred) to be between 2 to 5 pixels, but it might be any positive number up to third of the image width or height (the smaller of them).

4) Step 16, Contracting (or Stretching) the Contrast of the Smoothed Image Between Predefined Limits:

The contrast of the smoothed image is contracted (or stretched) to limit the perception of the smoothed image in Step 16. The contraction (or stretching) is using part of the possible range of the intensity values, to reserve the extreme (high and low) intensities for the enhanced edges and lines (the output of the edge detection and enhancement, step 12, I₁). It was found that the following contrast contraction (or stretching), which is a modification of the percentage linear contrast enhancement, has special advantages. In our modified version, the decision on the percentage of the intensity range of the smoothed image, which should be contracted (or stretched), is taken according to local inspection of the image, but it could be taken according to global consideration, and however, the contraction (or stretching) is done globally by the same degree for all the image locations, the procedure is:

1. Finding the column with the largest entropy:

$$C ( x ) = {max }_{y} H ( {I}_{2} ( o , y ) )$$

where I(o, y) is the column y of I(X, y), H(V) is the entropy of the column vector V:

$$H ( V ) = - {\sum }_{i} \frac{O ( {V}_{i} )}{N} \cdot log \frac{O ( {V}_{i} )}{N}$$

where O(Vᵢ) is the number of occurrences of Vᵢ in V, and N is the length of V, and

$${max}_{y} ( f ( y ) )$$

is the maximum value of the function f(y) .

2. Calculating the average AC, and the standard deviation SDC, of C(x):

$$AC = \frac{1}{N} {\sum }_{x} C ( x )$$

$$SDC = \sqrt{\frac{1}{N} {\sum }_{x} {( C ( x ) - AC )}^{2}}$$

3. Converting I₂ (x, y) to I₃ (x, y) according to the following rule:

$$\{ \begin{matrix}if A C - k \cdot SDC < {I}_{2} ( x , y ) < A C + k \cdot SDC then \\ {I}_{3} ( x , y ) = ( {I}_{2} ( x , y ) - ( A C - k \cdot SDC ) ) \cdot \frac{a - b}{2 \cdot k \cdot SDC} + b \\ else if {I}_{2} ( x , y ) \geq A C + k \cdot SDC then \\ {I}_{3} ( x , y ) = a \\ else \\ {I}_{3} ( x , y ) = b\end{matrix}$$

While a and b are upper and lower bounds, appropriately, of the new intensity range, and k is a positive number. The value of a is recommended to be 150 to 200, the values of b is recommended to be 25 to 75, but they can be any number in the intensity range, keeping the order of the upper and lower bounds. The value of k is recommended to be 0.5 to 2, but it can be any positive number keeping the calculation in the intensity range. In our practical use, AC−k·SDC is nearly 0 and AC+k·SDC is nearly 255, and this “contrast enhancement” actually shrinks the contrast and the intensity range of the smoothed image.

5) Step 18, Superimposing the Enhanced Edges and Lines (Step 12, I₁) on the Smoothed Contrast Enhanced Image (Step 16, I₃):

In Step 18, the enhanced edges and lines, appearing in I₁, are located and signed (superimposed) at the corresponding location in the smoothed and contrast-enhanced image, I₃. The superimposed edges and lines are prominent over their surrounding background. It is suggested to superimpose the edges and lines by using the extreme intensity values, namely, by using the maximum and minimum allowable intensity values (the brightest and the darkest values respectively). It was found that superimposing the edges and lines by using two adjacent lines, the darkest one and the brightest one, gives the best prominence, especially for the AMD patients. It was also found that the darkest line should be located at the low level side of the enhanced edge, and adjacent brightest line should be located at the high level side of the enhanced edge. One may set a threshold, or any other criterion, to determine which of the enhanced edges and lines should be superimposed on the smoothed and contrast enhanced image, and which should not. It was found that the following superimposing technique had special advantages, especially for the AMD patients, the procedure described above was carrie3d out as follows:

$$\{ \begin{matrix}if {I}_{1} ( x , y ) \geq A then \\ {I}_{4} ( x , y ) = 0 \\ else if {I}_{1} ( x , y ) \leq B then \\ {I}_{4} ( x , y ) = 255 \\ else \\ {I}_{4} ( x , y ) = {I}_{3} ( x , y )\end{matrix}$$

While A and B are the upper and lower thresholds, appropriately. The value of A is recommended to be in the range of 3 to 6, and the value of B is recommended to be −A, but they can be any real number with absolute value in the intensity range.

The process, starting at step 12 and ending at step 18, should be repeated for each of the image intensity channels, as defined in step 10.

As a result of the practice of the “Ullman-Zur enhancement” algorithm in the inventive method and apparatus of the present invention, an enhanced image is obtained is Step 20, usually in digital format, which can be then displayed on a screen or monitor or printed. Figuratively, one may describe the result of modifying the image by the “Ullman-Zur enhancement” algorithm as a replacement of each relevant line and edge by two adjacent lines, one is bright and one is dark, and the bright line is located at the brighter side of the background surrounding the two lines, and the dark line is located at the darker side of the background surrounding the two lines.

Although the specific preferred description of the invention, as set forth above, gives superb results, nevertheless in a broad statement of the invention, the method, and the apparatus of the present invention, may use any kind of edge detector and smoothing operator, to detect edges and lines, and to smooth the image. More specifically, any combination of DOG functions might be used to enhance, detect and smooth edges, lines, or any other image feature. In the practice of the invention, anyone of the following contrast enhancement techniques may be employed as a replacement for what is described above. Thus, one may use a contrast enhancement method, like linear enhancement, percentage linear enhancement, non-linear enhancement, or any other contrast enhancement, to enhance the contrast of the image. However, one may use the described contrast enhancement method of (Step 16) with fixed values of AC and SDC for all kind of images. On the other hand, one may use the innovative contrast enhancement described above (Step 16) to enhance the contrast of images for any general or special purpose. The values of AC and SDC might be set for each image according to the prior analysis of a specific region in the image (for example, a rectangle in the center of the image).

Also from the foregoing description and teaching the present invention, the use of an algorithm, which is equivalent, or similar, to any combination of the “edge detection and enhancement”, “smoothing the image”, “enhancing the contrast” (or actually “shrinking the contrast”), and “superimposing” of the results, Steps 12-18, like what is described above, may be employed to enhance the image for the visually impaired.

In some cases the convolution with the DOG enhances undesired features, which cannot be discarded even when optimal parameters are chosen for the DOG and the superimposing phase. Therefore, the addition of a filter before and/or after the superimposing phase is a modification that can yield good results where indicated. The filtering looks for continuation of the enhanced features (the superimposed pixels) in time (for frames of video stream), and for some kind of continuation in space like the enhancement of merely oriented small line segments.

With respect to the “Ullman-Zur enhancement” algorithm, adjustment of the algorithm parameters, to achieve the best subjective enhancement for each AMD individual, may be carried out according to the following table:

| Parameter | Influence |
|---|---|
| σ₀ | Increasing its value to create wider, and more continuous |
| | enhanced line (creating adjacent bright and dark lines), but |
| | with the expense of eliminating the enhancement of delicate |
| | lines/edges and joining close but separated lines/edges to a |
| | single enhanced line. In general, it has primary influence on |
| | the width and continuity of the enhanced lines, and secondary |
| | and weaker influence on the resolution of the enhanced lines. |
| β | Engineering consideration. |
| σ₁ | Increasing its value to create smoother image with less non- |
| | enhanced details. |
| k, a, b | Increasing the value of k and/or of a, b to create wider range |
| | of intensity for the smoothed image, but with the expense of |
| | loosing the prominence of the enhanced line. |
| A, B | Decreasing the value of A, B to create wider, and more |
| | continuous enhanced lines, but with the expense of enhancing |
| | some additional, less prominent lines/edges. In general, |
| | they have primary influence on the resolution (density) of the |
| | enhanced lines, and secondary and weaker influence on the |
| | width and continuity of the enhanced lines. |

Practically, three main parameters will be adjusted: σ₀ for the width of the enhanced lines, A, B for the density of the enhanced lines, and σ₁ for the smoothness of the image at the background. The adjustment might be performed by any mean supplied with the housing apparatus. For example, one may think of lookup table stored in a memory of an ASIC (Application Specific Integrated Circuit). The lookup table shall contain the parameters' values, and the algorithm, running on the ASIC, may use these values. The values at lookup tables may be updated, manually, according to the operation of the AMD patient (adjustment operation). The adjustment operation may be done directly at the apparatus, by a knob for example, or it can be done indirectly, by a wireless and remote control mean. The adjustment may be performed automatically according to some predefined damage criteria and measurement of the patients. The adjustment and the image modification according to the algorithm may be performed offline or in real-time. In case the adjustment and the modification are performed in real-time, they can be controlled by the observer of the image, whether it is an AMD patient or not.

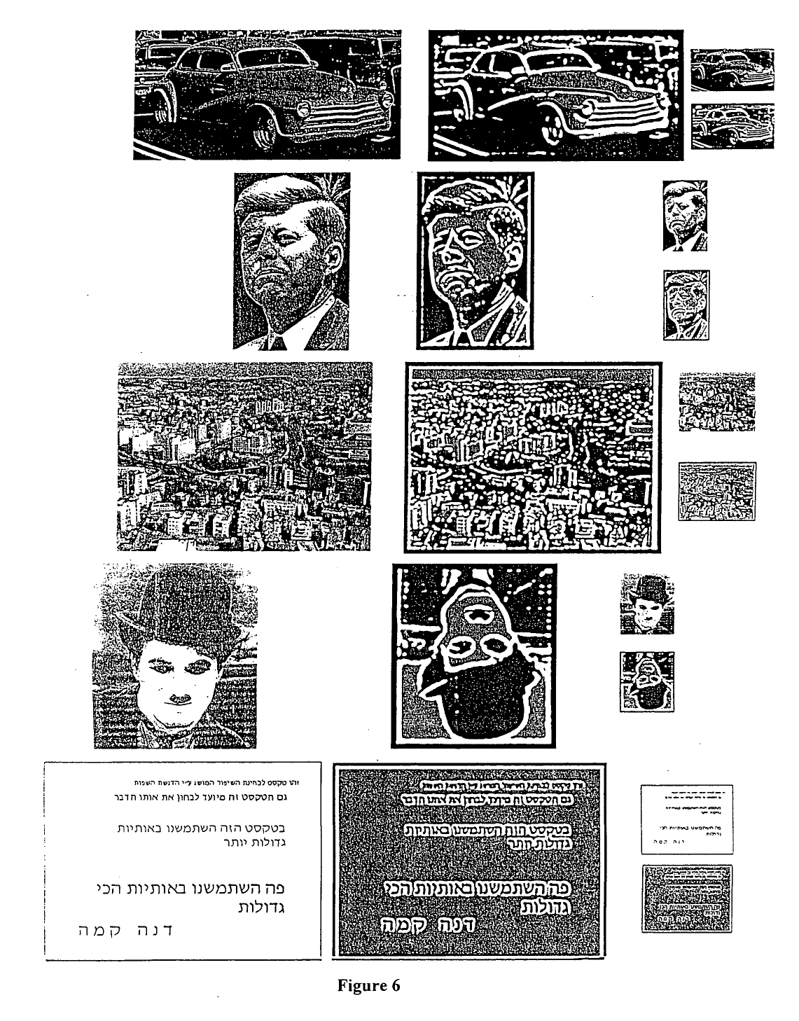

In case that a special treatment for characters is desired, then a characters preprocessing is turned on. The image is then first modified as follows (FIG. 5):

1) Step 30, Obtaining the Input Image:

The image is obtained in the format and channel which best serve the successor Optical Character Recognition (OCR) algorithm

2) Step 32, Detecting Characters in the Image:

An OCR algorithm is applied to detect characters in the image. The OCR algorithm is chosen from existing programs or may be developed to be efficient regarding the tradeoff between adequate detection ratio and rapid performance time.

3) Step 34 Decision Whether Text Detected:

In Step 34 a decision is made whether Text is detected, and if so, it is forwarded to Step 36.

3) Step 36, Replacing the Font of the Characters:

After the characters are identified, the font of the characters is replaced by the based font for AMD patients. This font right now is “Times new roman” in English and “David” in Hebrew.

4) Step 38, Replacing the Size of the Characters:

The characters size is replaced by the best size for AMD patients regarding normal reading distance. Right now the best size is 28.

5) Step 40, Adding Space Between Characters and Words:

An extra space tab is entered between each two adjacent characters of the word. A double space tab is entered between each two adjacent words. The line space is set to double.

6) Step 42, Enhancing the Contrast of the Characters Image:

The contrast between the characters and the background is set to maximum brightness and desired colors.

As a result of the practice of the characters preprocessing algorithm of the present invention, a preliminary enhanced characters image is obtained as an input to the “Ullman-Zur enhancement” algorithm (FIG. 4). The font type, the characters size, the characters, words and line space, and the brightness and color contrast are adjustable according to the patients' selection.

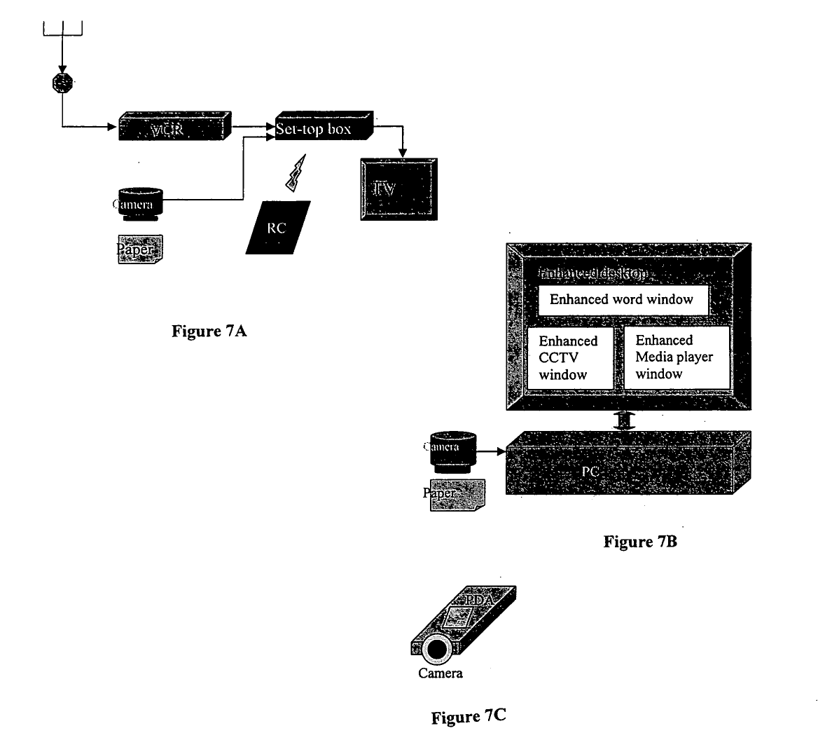

For example, the background at the output the “Ullman-Zur enhancement”, for a black and white characters image, is usually grayish with intermediate intensity. Some of the patients may choose the background to be more common with higher intensity, closer to white. In an improved version of the invention, preprocessing is effected to detect and enhance objects of specific interest, like the icons on the Windows desktop display in order to obtain similar details. Some examples for images and characters image and their enhancement are shown in FIG. 6. Figuratively, one may describe the result of applying the “Ullman-Zur enhancement” algorithm on a character's preprocessed image as adding one line adjacent to the edges of the characters, while the characters and the adjacent lines have high color contrast, and the background has intermediate color contrast (less color contrast between the background and the characters and between the background and the adjacent lines, compared with the contrast between the characters and the adjacent lines).

In case of stream of images, such as one encounters in the case of a video signal (Video), the images may be enhanced by the present invention by performing the inventive method including the “Ullman-Zur enhancement” algorithm, according to the present invention, or any modification of it, on each individual image, or any second, third image, or any selected part of the input stream, and by displaying the converted images, with or without the non-converted images or any part of them, thereby making it easier for the visually impaired to see the images more clearly and to discern their content more readily. To achieve minimum number of non-enhanced images in video stream, real-time consideration can be embedded in the “Ullman-Zur enhancement” algorithm. For example, each of the two-dimensional convolutions may be represented by successive one-dimensional convolutions, or by FFT transformation, and in general the algorithm may be modified to yield similar results but with less processing time. The example of performing the “Ullman-Zur enhancement” algorithm by using successive one-dimensional convolutions is presented below, by applying the following steps consecutively:

1) Step 50, Representing the Two-Dimensional DOG as Two Separated Two-Dimensional Gaussian Convolutions:

I₁=(G_{σ}_{₀}−G_{β·σ}_{₀})* I₀ is represented as I₁=G_{σ}_{₀}*I₀−G_{β·σ}_{₀}*I₀

2) Step 52, Replacing all the Two-Dimensional Gaussian Convolutions with Equivalent One-Dimensional Convolutions:

Each two-dimensional Gaussian

$${G}_{σ} ( x , y ) = \frac{1}{2 \prod {σ}^{2}} {ⅇ}^{\frac{{x}^{2} + {y}^{2}}{2 {σ}^{2}}} ,$$

is represented by multiplication of two one-dimensional Gaussians:

$${G}_{σ} ( x ) \cdot {G}_{σ} ( y ) = \frac{1}{\sqrt{2 \prod } σ} {ⅇ}^{\frac{{x}^{2}}{2 {σ}^{2}}} \cdot \frac{1}{\sqrt{2 \prod } σ} {ⅇ}^{\frac{{y}^{2}}{2 {σ}^{2}}} ,$$

and then the two-dimensional convolution can be implemented as two successive one-dimensional convolutions:

I=G_{σ}(x, y)*I₀=G_{σ}(y)*(G_{σ}(x)*I₀)

3) Step 54, Performing Only the One Dimensional Convolutions:

Whenever a two-dimensional Gaussian convolution (either the smoothing convolution or one of the DOG's convolutions, step 50) is to be performed, than the equivalent one-dimensional convolutions (step 52) are performed instead.

If the size of the discrete 2D Gaussian matrix is (K·σ)·(K·σ) elements then the size of each of the two equivalent one-dimensional Gaussian vectors is K·σ elements. The saving in processing time can be presented by the operations ratio, namely the ratio between the operations needed for the two-dimensional implementation and operations needed for the one-dimensional implementation. In our case the ratio is

$$\frac{K \cdot σ}{2}$$

for each performance of two-dimensional Gaussian convolution. For example, when using σ=3 pixels for the smoothing convolution and k=2.14 to include all the Gaussian values which are more than 1% of the Gaussian peak value, than the matrix dimensions should be 7*7 pixels and implementing the one-dimensional convolution will be 4.5 times rapider than the two-dimensional implementation. It was found that using the one-dimensional implementation for the “Ullman-Zur enhancement” algorithm for video stream of 25 images per second requires around 25 MOPS (Millions Operation Per Second) while using the two-dimensional implementation requires around 120 MOPS. Additional save in performance time can be achieved by approximating the one-dimensional Gaussians by successive convolutions of step functions, but this saving is effective only for large σ and matrix size. At the size of σ's and matrices (k=2.14) we are using now, we haven't found this approximation effective, but we might use it in the future for larger matrices.

An alternative example to reduce the performance time of the “Ullman-Zur enhancement” algorithm during the practice of the invention is using the FFT transform. The FFIT transform converts a convolution to multiplication, and therefore reduces the computation complexity significantly:

FFT(f(x, y)*g(x, y))=FFT(f(x, y)) FFT(g(x, y))

However, the FFT operation by itself is time consuming. For a matrix with m rows and n columns, the FFT transform requires m·n·log(m·n) operations. In our case, we can neglect the conversion of the DOG and the smoothing matrices, which is done once in advance, but we have to convert each time the original image, and to apply the inverse transform to the resulted in images after the DOG and the smoothing convolutions. Therefore, the number of operations needed for the “Ullman-Zur enhancement” algorithm using the FFT transform is at the order of 3·log(m·n)·m·n, where m and n, are the number of the rows and the columns of the images appropriately. On the other hand, when using the one-dimensional convolution sequence to perform the “Ullman-Zur Enhancement” algorithm, the number of operation is at the order of k·σ·m·n. Therefore, assuming the images size do not change, for small DOG and smoothing matrices the one-dimensional convolution yields better real-time performances, and for large DOG and smoothing matrices the FFF transform can yields better real-time performances. In our case, the image size is 512*512 pixels and the DOG and smoothing matrices is 7*7 pixels, the one-dimensional convolution is clearly preferred. An advantage to one of the timesaving methods can arise from the type of microprocessor being used. There are some DSP's (Digital Signal Processors) supporting FFT transform, and many DSP's supports the one-dimensional convolution. At this phase we intend to use either general-purpose processors, or the MAP-CA processor by “Equator” which support the one-dimensional convolution, and therefore the one-dimensional convolution implementation has clear advantage in our case.

In case of color images, the “Ullman-Zur” algorithm is applied as followed:

1) Step 70, Present the Image in HSV Format:

For each pixel, V=max(R,G,B), S=(V−min(R,G,B))/V, and H is a function of the (R,G,B) channels.

2) Step 72, Adapted Enhancement and Smoothing:

Apply step 12 to the V channel (DOG enhancement), and step 14 (smoothing) to the original three R,G,B channels.

3) Step 74, Contrast Enhancement of the Smoothed Image:

Apply step 16 to the max(R,G,B) of the smoothed image (the smoothed V channel). Change the rest of the two channels of the (R,G,B) smoothed image appropriately keeping the relation between the (R,G,B) channels of each pixel of the smoothed image

$$( \frac{{R}_{before}}{{G}_{before}} = \frac{{R}_{after}}{{G}_{after}} , \frac{{G}_{before}}{{B}_{before}} = \frac{{G}_{after}}{{B}_{after}} ) .$$

4) Step 76, Superposition:

Apply step 18 to the DOG enhanced V channel, and for each pixel of the smoothed and contrast enhanced image put it instead of (R,G,B) channel that it was originally taken from. For each pixel change the rest of the (R,G,B) channels appropriately to keep the original relation between the (R,G,B) channels

$$( \frac{{R}_{before}}{{G}_{before}} = \frac{{R}_{after}}{{G}_{after}} , \frac{{G}_{before}}{{B}_{before}} = \frac{{G}_{after}}{{B}_{after}} ,$$

but If the superimposed V channel was set to zero, set the other two channels also to zero).

The described above method and apparatus invention may include or be combined with the common methods and apparatus presently known-and used for the visually impaired, which are described in the prior art section, such as magnification and contrast enhancement. The combined use of the known conventional techniques with the new proposed inventive techniques of the disclosed method can enable use of less magnification (to lose less area of the visual field) or less contrast enhancement (to leave the image more natural and vivid). However, as described above and below the variant versions of the proposed method can use some level of contrast enhancement to emphasize the enhanced features.

The following versions of the invention involve modifications to the unique algorithms that enable the change of density, regularity, and contrast, according to prominence and negligibility, of any feature, specifically dots and textural patterns. Textural patterns can become more regular, denser and with high contrast. Later version of the algorithm will include the replacement of, and change of shape, size, density and regularity of image features according to templates of the features. Template is an instance of a specific feature, stored and pre-tested in advance to achieve optimal perception of the feature. For example, specific objects, such as the mouth and nose of the face, may be replaced with similar templates which are best filled-in. Lines and edges in the image may be replaced by a patch of grating of lines (a bunch of adjacent parallel lines), a Gabor patch of lines (a grating of lines with declined intensity, mathematically represented as a grating multiplied by a centered Guassian function), or two adjacent lines one is bright and one is dark. The bright line may have extreme intensity and may be located at the brighter side of the surroundings while the dark line may also have extreme intensity and may be located at the darker side of the surrounding, as the enhancing lines are usually produced by the Ullman-Zur algorithm. Lines and texture may be replaced by lines or texture patterns which are denser, more regular, or have higher contrast. Adjacent lines might be added to the edges of detected characters (in similar way to the result of applying the “Ullman-Zur algorithm” on a character image) to induce high contrast between the characters and the adjacent lines while the background has intermediate intensity. Enhancing features, such as adjacent lines, may be reduced and balanced by spatial and temporal filters to eliminate undesired effects perceived as noise or flickering. The filters can be oriented in space to select specific orientation, or continuous in time to induce temporal continuity. The background of the image (the image features which are not enhanced) might be differentiated from the foreground (aggregation of the image features which are enhanced) by defined rules, such as threshold mechanism. In the threshold mechanism, only image features that pass the threshold criteria will be enhanced. The rest of the features (the background) can be smoothed, or their contrast might be contracted or stretched in order to become less prominent and to relatively add visual enhancement to the foreground.

The apparatus of the present invention is a computer programmed, or hardware designed, as described herein with reference to FIGS. 4 and 5, and may consist of a microprocessor, or an ASIC, with requisite I/O, storage and monitor as noted. The microprocessor/ASIC is programmed/designed to perform the “Ullman-Zur enhancement” algorithm and the accompanied methods as described in the foregoing, particularly with reference to FIGS. 4 and 5. Further, the apparatus for performing the “Ullman-Zur enhancement” algorithm may include as a component and/or be housed, at least, in one of the following apparatus:

1) “Set top” box at the input of TV (Television) set or VCR (Video Cassette Recorder)—end user enhancement.

2) The server of a TV content provider, like the local Cable station (server enhancement).

3) Digital TV, like high definition TV

4) DVD (Digital Versatile Disc)

5) Head mounted display

6) Close Circuit TV

7) Computer Card, like display card

8) Computer software

9) PDA (Personal Digital Assistant), Handheld computers, or Pocket PC's (Personal Computer).

10) Multimedia Players

11) Computer card or computer software of Internet server.

12) Chip set designed for any analog and/or digital apparatus.

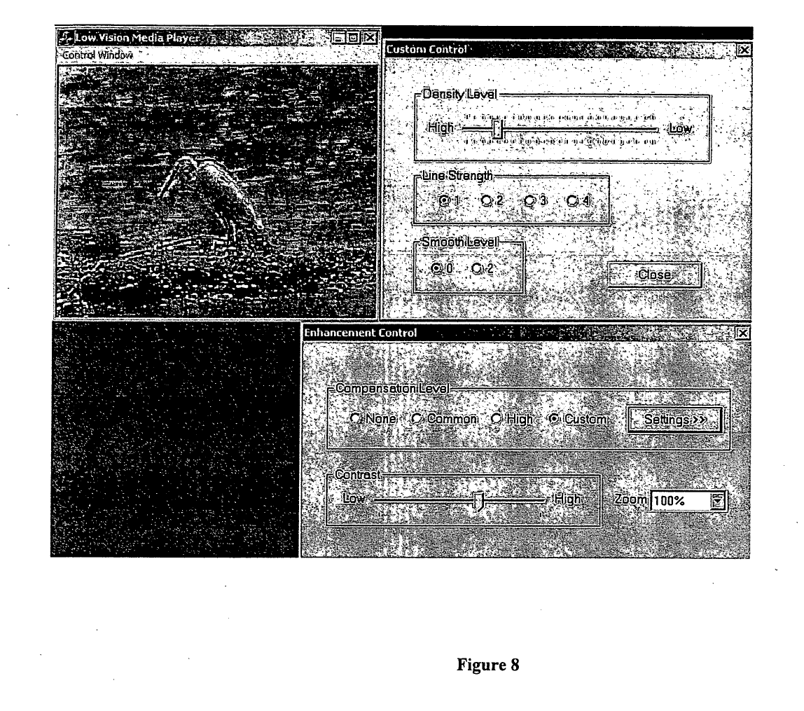

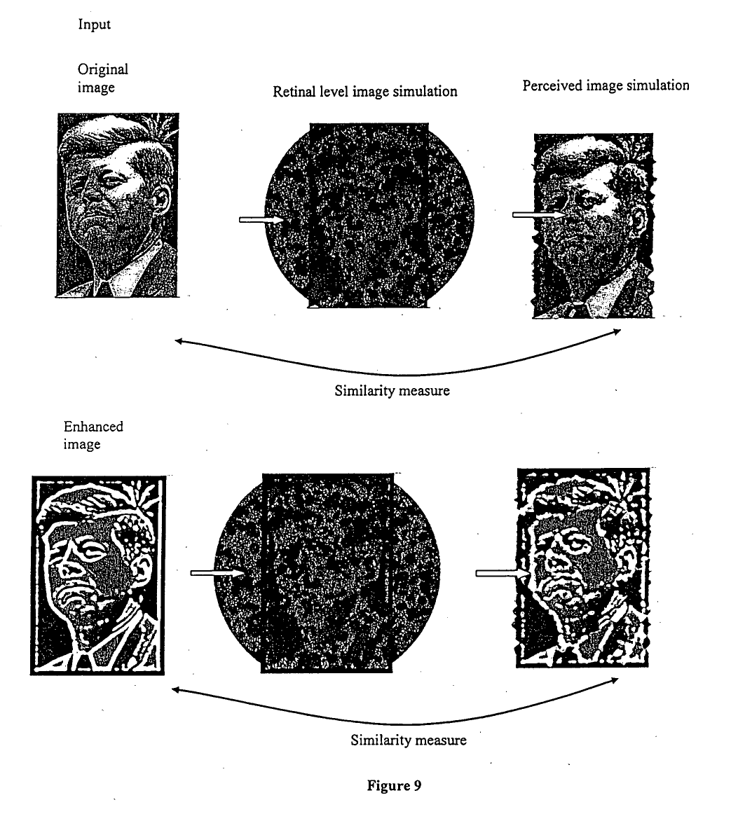

FIGS. 7A, 7B and 7C present examples of housing the algorithm in a TV set environment and in a personal computer environment. FIG. 8 presents a demonstration of enhanced image (part of video stream), and the HMI to control the enhancement adjustable parameters.

In order to obtain information about or to test the quality of the enhanced image, like an image enhanced by the “Ullman-Zur enhancement” algorithm, one of several techniques may be employed by the present invention. The quality of the enhanced image for an AMD individual may be tested, at least, by one of the following techniques:

1) Size Test:

1. Present the image to the subject with size, which is below the recognition or perception threshold.

2. Increase the image size gradually.

3. Let the subject to sign when he/she first identified the object or perceive the feature in the image.

4. Rank the quality of the image according to the identification or the perception size. The rank is higher as the size is smaller.

(For AMD perception test, the subject should be AMD patient)

2) Contrast Test:

1. Present the image to the subject with contrast, which is below the recognition or perception threshold.

2. Increase the image contrast gradually.

3. Let the subject to sign when he/she first identified the object or perceive the feature in the image.

4. Rank the quality of the image according to the identification or the perception contrast. The rank is higher as the contrast is lower.

(For AMD perception test, the subject should be AMD patient)

3) Simulation Test:

The uniqueness of the simulation test is that it can be performed by a normal observer, without intervention of the subject with the specific effects, like the AMD patient in the case of AMD perception test.

1. Use a transformation, which simulates the damages and the effects (like the retinal damage and the cortical filling-in effect of the AMD disease), which you want to ease by the enhancement.

2. Use the transformation to convert the enhanced image.

3. Use the transformation to convert the original image.

4. Rank, by normal observer (not affected by the tested effect), the similarity of the converted original image to its origin (non-converted image), and the similarity of the converted enhanced image to its origin (non-converted enhanced image).

5. Rank the superiority of the enhanced image according to the superiority of its similarity rank (step 4 of this test) over the similarity rank (step 4 of this test) of the original image.

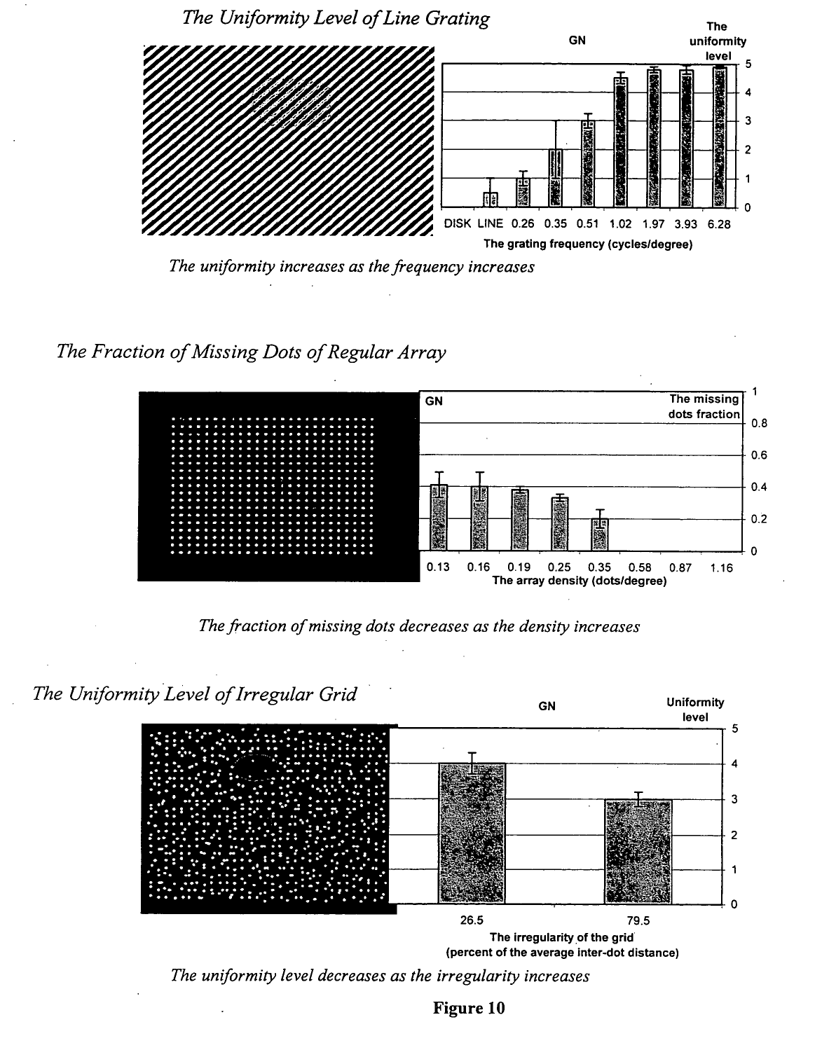

An example for a test and transformation simulating the retinal damage and the perceptual effects of the AMD disease is shown in FIG. 9, which is self-explanatory.

A refinement of the present invention can include the steps of measuring the severity of the damage of the patient. This severity measure may induce the amount of the enhancement needed, and may help to adjust the parameters of the “Ullman-Zur enhancement” algorithm. The severity of the damage of an AMD patient may be measured, at least, by one of the following functional tests, based on the infrastructure of the filling-in effect:

1. Testing Uniformity Level of Perceived Grating

1) Start with presenting the grating with lowest frequency

2) Ask the patient to qualitatively rank the uniformity of the grating by number between 0 (non-uniform) to 5 (uniform), or by any other mean. (the non-uniform region usually appears in the scotomas region)

3) Increase the grating frequency

4) If the grating frequency is lower or equal to the predetermined maximum frequency, then present the grating and return to 2).

2. Testing the Fraction of Missing, Blurred, and Partial Dots at the Perceived Regular Array of Dots:

1) Start with presenting the array with lowest density

2) Ask the subject to report the number of missing dots, blurred dots and partial dots

3) Increase the array density.

4) If the array density is lower or equal to the predetermined maximum density, then present the array and return to 2).

5) For each density, compute the fraction of missing, blurred, and partial dots, by dividing the number of missing, blurred and partial dots with the number of dots that should have fallen in the scotoma region (the scotoma size should be measured in advance by tool like visual field mapping, or according to the analysis of the retinal photograph).

3. The Uniformity Level of Perceived Irregular Array of Dots.

1) Start with presenting the array with lowest irregularity

2) Ask the patient to qualitatively rank the uniformity of the irregular array (the non-uniformity may appear, for example, as a change in the local density at the scotoma region from the average density of the surroundings) by number between 0 (non-uniform) to 5 (uniform), or by any other mean.

3) Increase the array irregularity

4) If the array irregularity is lower or equal to the predetermined maximum irregularity, then present the array and return to 2).

For each of the foregoing tests, the results should better be compared with the statistical data of AMD patients, containing information about the relation between the severity of the damage and the tests results. Such a database should better be created in advance, at a phase which should be called learning phase, and may precede the practical use of the tests. An example for the foregoing tests is shown in FIG. 10.

One may use the foregoing tests, or any modification of them, based or non-based on the filling-in phenomenon, for any other general or specific purpose, to test AMD subjects or any other type of subjects.

The method and apparatus of the present invention has general application for the purpose of enhancement using the “Ullman-Zur enhancement” algorithm, as described in the foregoing. Examples of such purposes include:

1) Visual disorders purpose: Enhancing images for any visual disorder or eye and brain diseases, in order to achieve, for example, maximum visibility while keeping the perceptual equality, or for any other purpose.

2) Military purpose: Thermal images, infrared images, and night-sight images

3) Medical purpose: Laser imaging, ultrasound imaging

4) Domestic and Entertainment purpose: video images, computer display and images, and images transferred through telemetric connection, like the Internet.

From the foregoing description, the present invention, as specifically portrayed, can be incorporated into a more generalized system for image modification. To this end, the method including the application of the enhancement algorithm and apparatus of the present invention may be incorporated as part of a more generalized system for image modification such as is described below:

1) The input of the system may be still or video images in any standard or non-standard format.

2) The system converts the input images according to any defined transformation.

3) The output images are the converted images with the input format or in any other standard or non-standard format.

Further, according to the invention, the method and apparatus of the inventive system for image modification can be adjusted in a variety of ways:

1) The parameters of the system transformation are adjustable.

2) The parameters, influencing the system transformation, and influencing the output modified image, can be adjusted individually, or in combination.

3) The adjustment might be done manually or automatically according to preprocessing, learning process, preceding test phase, online computation, or any other available technique.

Although the invention has been shown and described in terms of preferred embodiments, nevertheless various modifications and changes are possible which do not depart from the teaching herein. Such changes and modifications are deemed to fall within the purview of the present invention as claimed.

### CITATIONS

1. Dagnelie G, Massof R, “Toward and artificial eye” IEEE Spectrum May 1996

2. Clarck S A, Allard T, Jenkins W M, Merzenich M M, 1988 “Receptive Field in the Body—Surface Map in Adult Cortex defined by Temporally Correlated Inputs” Nature 332 444-445

3. Arditi A 1995 “Color Contrast and Partial Sight” A Publication of the Gordon Research Institute, The Lighthouse Inc., New York, N.Y.

4. Newell W F, 1982 “Ophthalmology, principles and concepts” 5th ed (St. Louis: The CV Mosby Company) pp 92-95

5. Unknown author, 1997 “Don't lose Sight of Age-Related Macular Degeneration”, NIH Publication No. 96-4032, National Eye Institute—National Institute of Health, 2020 Vision Place, Bethesda, Md.

6. Unknown author, 1997 “Don't loose Sight of Diabetic Eye Disease”, NIH Publication No. 93-3252, National Eye Institute—National Institute of Health, 2020 Vision Place, Bethesda, Md.

7. Graham L, 1996 “What is RP” A BRPS publication, The British Retinitis Pigmentosa Society, Greens Norton, Towcester, Northamptoshire.

8. Rosental B P, Cole R G, (eds.) 1996 “Functional Assessment of the Low Vision” (St. Louis: The CV Mosby Company)

9. Bressler S B, Maguire M G, Bressler N M, Fine S L, 1990 “Macular Photocoagulation Study Group, Relationship of drusen and abnormalities of the retinal pigment epithelium to the prognosis of neovascular macular degeneration” Arch. Ophthalmology 110 1442-1447.

10. De Juan E, Humayun M S, Philips H D, 1993 “Retinal Microstimulation” U.S. Pat. No. 5,109,844

11. Liu W, McGucken E, Vichiechom K, Clements M, De Juan E, Humayum M S, 1997 “Dual Unit Retinal Prosthesis” IEEE EMBS97

12. Humayun M S, De Juan E, Dagnelie G, Greenberg R J, Propst R H, Philips H D, 1996 “Visual Perception Elicited by Electrical Stimulation of Retina in Blind Humans by Electrical Stimulation of Retina in Blind Humans” Arch. Ophthalmol 114 4046

13. Vichiechom K, Clements M, McGucken E, Demarco C, Hughes C, Liu W, 1998 “MARC2 and MARC3 (Retina2 and Retina3)” Technical Report

14. Peli E, 1999 “Simple 1-D image enhancement for the head mounted low vision aid” Visual Impairment Research 1 3-10

15. Peli E, 2000 “Image modification method for enhancing real world view for the visually impaired”, Pat. No. WO 200012429

16. Peli E, Goldstein R B, Young G M, Tremp C L, Buzney S M, 1991 “Image enhancement for the visually impaired: Simulation and experimental results” Invest. Ophthalmol. Vis. Sci. 32 2337-2350

17. Ramachadran V S, 1992 “Blind spots” Scientific American 266 44-49

18. Ramachadran V S, Gregory R L, 1991 “Perceptual filling-in of artificially induced scotomas in human vision” Nature 350 699-702

19. Kawabata N, 1982 “Visual information processing at the blind spot” Perceptual and Motor Skills 55 95-104

20. Kawabata N, 1984 “Perception at the blind spot and similarity grouping” Perception and Psychophysics 36 151-58

21. Kawabata N, 1990 “Structural information processing in peripheral vision” Perception 19 631-36

22. Motoyoshi I, 1994 “A real masking of a texture pattern: basic properties and its implications for the filling-in process” Proceedings of Tohoku Psychology Association 44 49

23. Motoyoshi I, 1999 “Texture filling-in and texture segregation revealed by transient masking” Vision Research 39 1285-1291

24. Murakami I, 1995 “Motion after effect after monocular adaptation to filled-in motion at the blind spot” Vision Research 35 1041-1045

25. Murakami I, Komatsu H, Kinoshita M, 1997 “Perceptual filling-in at the artificial scotoma following a monocular retinal lesions in the monkey” Visual neuroscience 14 89-101

26. Gilbert C D, Wiesel T N, 1992 “Receptive field dynamics in adult primary visual cortex” Nature 356 150-152

What is claimed is:

1. A method for enhancing an image for a visually impaired person, comprising the steps of determining at least one discrete feature of an image, and modifying the determined feature to alter its appearance to a visually impaired person.

2. The method of claim 1 further including the step of at least one of magnification of the image, contrast enhancement of the whole image, contrast enhancement of local frequency range of the image and contrast enhancement of local spatial range of the image.

3. The method of claim 1 wherein the step of modifying the determined feature includes the step of at least one of adding, removing, enhancing and diminishing the determined feature.

4. The method of claim 1 wherein the image is obtained from a video stream.

5. The method of claim 4 wherein the modification occur offline before the image is presented.

6. The method of claim 4 wherein the modification occur in real-time while the images are presented.

7. The method of claim 1 wherein the modification is controlled in real-time by a human observer of the image.

8. The method of claim 1 wherein the step of modifying the determined feature includes the step of changing the spatial density in the image.

9. The method of claim 1 wherein the step of modifying the determined feature includes the step of changing the spatial regularity of the image.

10. The method of claim 1 wherein the step of modifying the determined feature includes the step of changing the size and shape of the image.

11. The method of claim 1 wherein the step of modifying the determined feature includes the step of replacing said feature in the image with a template of the same type.

12. The method of claim 1 wherein the step of modifying the determined feature includes the step of changing selectively part of the feature of the image according to predefined rules.

13. A method for enhancing an image for a visually impaired person, comprising the steps of modifying discrete features of the image to alter their appearance to a visually impaired person.

14. A method for enhancing an image according to claim 13 further including the steps of enhancing selectively part of the features of the image according to predefined rules, and diminishing the rest of the image.

15. A method for enhancing an image according to claim 14 including the step of spatially smoothing the background.

16. A method for enhancing an image according to claim 14 wherein the background is contracted to intermediate intensities.

17. A method for enhancing an image according to claim 14 wherein the background is stretched to a bounded range of intensities.

18. A method of enhancing an image comprising the steps of determining relevant discrete lines and discrete edges in the image, and enhancing the determined lines and images.

19. A method of enhancing an image according to claim 18 wherein the relevant lines and edges in the image are enhanced by replacing each relevant line or edge by a combination of a line adjacent to an edge.

20. A method of enhancing an image according to claim 18 wherein the relevant lines and edges in the image are enhanced by replacing each relevant line and edge by a patch of line grating.

21. A method of enhancing an image according to claim 18 wherein the relevant lines and edges in the image are enhanced by replacing each relevant line and edge by a Gabor patch.

22. A method of enhancing an image according to claim 18 wherein the relevant lines and edges in the image are enhanced by replacing each relevant line and edge by two adjacent lines, one bright and one dark.

23. A method of enhancing an image according to claim 18 wherein the relevant lines and edges in the image are enhanced by replacing each relevant line and edge by two adjacent lines, one bright and one dark, and the bright line is located at the brighter side of the background surrounding the two lines, and the dark line is located at the darker side of the background surrounding the two lines.

24. A method of enhancing an image according to claim 18 wherein the relevant lines and edges in the image are enhanced by replacing each relevant line and edge by two adjacent lines, one bright and one dark, and the intensity of the lines is stretched to extreme values.

25. A method of enhancing an image according to claim 18 wherein the relevant lines and texture patterns in the image are enhanced.

26. A method of enhancing an image according to claim 25 wherein the relevant lines and texture patterns in the image are enhanced by making them spatially denser.

27. A method of enhancing an image according to claim 25 wherein the relevant lines and texture patterns in the image are enhanced by making them more spatially regular.

28. A method of enhancing an image according to claim 25 wherein the relevant lines and texture patterns in the image are enhanced by stretching the intensity of the lines and texture elements to extreme values.

29. A method for enhancing an image comprising the steps of detecting characters in an image, and enhancing the detected characters.

30. A method according to claim 29 wherein lines and characters in the image are enhanced by modifying their size.

31. A method according to claim 29 wherein the lines and characters in the image are enhanced by modifying line attributes and fonts of the characters.

32. A method according to claim 29 wherein the lines and characters in the image are enhanced by modifying the space between lines and between characters.

33. A method of enhancing an image according to claim 29 wherein relevant lines and texture patterns in the image are enhanced by modifying the space between lines, between characters, and between words.

34. A method according to claim 29 wherein lines and characters in the image are enhance by modifying contrast of the lines, characters and their background.

35. A method according to claim 29 wherein a line grating is added adjacent to lines and to edges of the characters.

36. A method according to claim 29 wherein a Gabor patch is added adjacent to lines and to edges of the characters.

37. A method according to claim 29 including the further step of adding a line adjacent to existing lines, and/or to edges of the characters.

38. A method according to claim 29 wherein a line is added adjacent to existing lines, and to edges of the characters, while the intensity of the characters and their adjacent lines have extreme values in an opposed way, and the background of the characters with the adjacent lines having intermediate intensity value.

39. A method according to claim 29 wherein a line is added adjacent to existing lines, and to edges of characters, with the characters and the adjacent lines have high color contrast, and their background having intermediate color contrast.

40. A method of enhancing an image according to claim 25 wherein the changed features are reduced by spatial filtering.

41. A method of enhancing an image according to claim 25 wherein the changed features are reduced by temporal filtering.

42. A method of enhancing an image according to claim 25 wherein the changed features are reduced by spatially oriented filtering.

43. A method of enhancing an image according to claim 25 wherein the changed features are reduced by temporally continuous filtering.

44. An image enhancement method for enhancing relevant features of an image comprising the following steps:
e. capturing the intensity channel of the image;
f. detecting and signing the relevant features in the intensity channel of the image;
g. changing discrete relevant features in the intensity channel of the image; and
h. compensating the rest of the channels for the change.

45. An image enhancement method comprising the steps of:
h. capturing the intensity channel of the image;
i. detecting and signing the relevant features in the intensity channel of the image;
j. smoothing the original image;.
k. contracting or stretching the intensity channel of the smoothed image between predefined intensity limits;
l. compensating the rest of the channels for the contraction or stretching;
m. changing the relevant features in the intensity channel of the contrast contracted or stretched and smoothed image; and
n. compensating the rest of the channels for the change;
whereby relevant features of the image are enhanced and background of an image diminished.

46. An image enhancement method according to claim 45 wherein step f includes superimposing substituting features for the relevant edges and lines on the intensity channel of the contrast contracted (or stretched) and smoothed image.

47. An image enhancement method according to claim 45 wherein step f includes making relevant lines and texture patterns denser and more regular in the intensity channel of the contrast contracted (or stretched) and smoothed image.

48. An image enhancement method that substitutes relevant edges and lines with two adjacent lines and diminishes the background of the image comprising the following steps:
h. capturing the intensity channel I₀ (x, y) of the image Im₀ (x, y)
i. signing the relevant edges and lines by convoluting the intensity channel of the original image with Difference of Gaussian (DOG):
I₁=(G_{σ}_{₀}−α·G_{β·σ}_{₀})*I₀
Where G_{σ}(x, y) is a Gaussian function with zero average and σ Standard deviation,
$${G}_{σ} ( x , y ) = \frac{1}{2 \prod {σ}^{2}} {ⅇ}^{\frac{{x}^{2} + {y}^{2}}{2 {σ}^{2}}}$$
α is the balance ratio and β is the space ratio;
j. smoothing all the channels of the original image by convoluting it with an average operator, such as a gaussian smoother:
Im₂=G_{σ}_{₁}*Im₀
k. contracting (or stretching) the contrast of the intensity channel of the smoothed image between predefined limits, by using percentage enhancement:
$$\{ \begin{matrix}if {K}_{1} < {I}_{2} ( x , y ) < {K}_{2} then \\ {I}_{3} ( x , y ) = ( {I}_{2} ( x , y ) - {K}_{1} ) \cdot \frac{{M}_{2} - {M}_{1}}{{K}_{2} - {K}_{1}} + {M}_{1} \\ else if {I}_{2} ( x , y ) \geq {K}_{2} then \\ {I}_{3} ( x , y ) = {M}_{2} \\ else \\ {I}_{3} ( x , y ) = {M}_{1}\end{matrix}$$
where K₁ and K₂ are lower and upper limits, appropriately, in the intensity channel of the smoothed image, and M₁ and M₂ are lower and upper limits, appropriately, in the intensity channel of the contracted (stretched) image;
l. compensating the rest of the channels of Im₃ (x, y) for the contraction (or stretching);
m. superimposing the two adjacent lines on the relevant edges and lines in the intensity channel of the contrast contracted (stretched) and smoothed image by using the following rule:
$$\{ \begin{matrix}if {I}_{1} ( x , y ) \geq A then \\ {I}_{4} ( x , y ) = 0 \\ else if {I}_{1} ( x , y ) \leq B then \\ {I}_{4} ( x , y ) = 255 \\ else \\ {I}_{4} ( x , y ) = {I}_{3} ( x , y )\end{matrix}$$
where A and B are the upper and lower thresholds; and
n. compensating the rest of the channels of Im₄ (x, y) for the superimposition (f).

49. An image enhancement method that substitutes relevant edges and lines with two adjacent lines and diminishes the background of an image by using HSV and RGB color image formats comprising the following steps:
g. capturing the intensity channel V₀ (x, y)=max(R₀, G₀, B₀) of the image IM₀(x,y);
h. signing the relevant edges and lines by convoluting the intensity channel of the original image with Difference of Gaussian (DOG):
V₁=(G_{σ}_{₀}−α·G_{β·σ}_{₀})*V₀
where G_{σ}(x, y) is a Gaussian function with zero average and σ Standard deviation,
$${G}_{σ} ( x , y ) = \frac{1}{2 \prod {σ}^{2}} {ⅇ}^{\frac{{x}^{2} + {y}^{2}}{2 {σ}^{2}}}$$
α is the balance ratio and β is the space ratio;
i. smoothing all the channels of the original image (R₀,G₀,B₀) by convoluting it with an average operator, such as a gaussian smoother:
Im₂=G_{σ}_{₁}*Im₀
j. contracting (or stretching) the contrast of the intensity channel of the smoothed image V₂=max(R₂,G₂,B₂) between predefined limits, by using percentage enhancement:
$$\{ \begin{matrix}if {K}_{1} < {V}_{2} ( x , y ) < {K}_{2} then \\ {V}_{3} ( x , y ) = ( {V}_{2} ( x , y ) - {K}_{1} ) \cdot \frac{{M}_{2} - {M}_{1}}{{K}_{2} - {K}_{1}} + {M}_{1} \\ else if {V}_{2} ( x , y ) \geq {K}_{2} then \\ {V}_{3} ( x , y ) = {M}_{2} \\ else \\ {V}_{3} ( x , y ) = {M}_{1}\end{matrix}$$
where K₁ and K₂ are lower and upper limits, appropriately, in the intensity channel of the smoothed image, and M₁ and M₂ are lower and upper limits in the intensity channel of the contracted (stretched) image;
k. compensating the rest of the channels of Im₃ (x, y) for the contraction (or stretching) by keeping the relations
$$\frac{{R}_{3}}{{G}_{3}} = \frac{{R}_{2}}{{G}_{2}} , \frac{{G}_{3}}{{B}_{3}} = \frac{{G}_{2}}{{B}_{2}} ;$$
l. superimposing the two adjacent lines on relevant edges and lines in the intensity channel of the contrast contracted (stretched) and smoothed image by using the following rule:
$$\{ \begin{matrix}if {V}_{1} ( x , y ) \geq A then \\ {V}_{4} ( x , y ) = 0 \\ else if {V}_{1} ( x , y ) \leq B then \\ {V}_{4} ( x , y ) = 255 \\ else \\ {V}_{4} ( x , y ) = {V}_{3} ( x , y )\end{matrix}$$
where A and B are the upper and lower thresholds; and
g.) compensating the rest of the channels of Im₄ (x, y) for the superimposition by keeping the relations
$$\frac{{R}_{4}}{{G}_{4}} = \frac{{R}_{3}}{{G}_{3}} , \frac{{G}_{4}}{{B}_{4}} = \frac{{G}_{3}}{{B}_{3}} .$$

50. An image enhancement method according to claim 45 in which the smoothness level of the background is controlled in offline.

51. An image enhancement method according to claim 45 in which the smoothness level of the background is controlled in real-time.

52. An image enhancement method according to claim 45 in which the contraction (or stretching) level of the background is controlled in offline.

53. An image enhancement method according to claim 45 in which the contraction (or stretching) level of the background is controlled in real-time.

54. An image enhancement method according to claim 45 in which the density of the enhancing lines is controlled in offline.

55. An image enhancement method according to claim 45 in which the density of the enhancing lines is controlled in real-time.

56. An image enhancement method according to claim 45 in which width of enhancing lines is controlled in offline.

57. An image enhancement method according to claim 45 in which width of enhancing lines is controlled in real-time.

58. An image enhancement method according to claim 45 in which regularity of enhanced texture is controlled in offline.

59. An image enhancement method according to claim 45 in which the regularity of the enhanced texture is controlled in real-time.

60. An image enhancement method according to claim 45 in which density of enhanced texture is controlled in offline.

61. An image enhancement method according to claim 45 in which density of enhanced texture is controlled in real-time.

62. An image enhancement method according to claim 45 including substituting relevant edges and lines with two adjacent lines and diminishing background of an image, in which the smoothness of the background is controlled by the width of the Gaussian G_{σ}_{₁}.

63. An image enhancement method according to claim 45 that substitutes the relevant edges and lines with two adjacent lines and diminishes the background, in which the contraction (or stretching) level of the background is controlled by the lower and upper limits values K₁, K₂ , M₁, M₂.

64. An image enhancement method according to claim 45 that substitutes the relevant edges and lines with two adjacent lines and diminishes the background, in which the density and the width of the enhancing lines is controlled by the parameters of the DOG, G_{σ}_{₀}−α·G_{β·σ}_{₀}, and the thresholds values A and B.

65. An image enhancement method according to claim 45 that substitutes the relevant edges and lines with two adjacent lines and diminishes the background, in which the two-dimensional convolutions are implemented by an equivalent successive one-dimensional convolutions.

66. An image enhancement method according to claim 45 that substitutes the relevant edges and lines with two adjacent lines and diminishes the background, in which the two-dimensional convolutions are implemented by an equivalent FFT transformations.

67. A character image enhancement method, comprising the following steps:
c. manipulating the lines and characters in the image, and
d. applying an image enhancement method according to claim 45 on the manipulated image to enhance discrete lines and characters in the image.

68. A method according to claim 67 wherein the lines and characters in the image are manipulated by using the following steps:
j. capturing the intensity channel of the image;
k. detecting and signing the lines and characters in the intensity channel of the image by using an Optical Characters Recognition (OCR) or threshold algorithm;
l. changing the attributes of the lines and fonts of the characters in the intensity channel of the image;
m. changing the size of the lines and characters in the intensity channel of the image;
n. changing the space between the lines and characters in the intensity channel of the image;
o. changing the space between words in the intensity channel of the image;
p. changing the color contrast between the lines and characters and their background;
q. changing the brightness contrast between the lines and characters and their background;
r. compensating the rest of the channels for the changes.

69. A method according to claim 67 that applies the following image enhancement method on the manipulated lines and characters:
g. capturing the intensity channel V₀ (x, y)=max(R₀, G₀, B₀) of the image IM₀(x, y);
h. signing the relevant edges and lines by convoluting the intensity channel of the original image with Difference of Gaussian (DOG):
V₁=(G_{σ}_{₀}−α·G_{β·σ}_{ₒ})*V₀
where G_{σ}(x, y) is a Gaussian function with zero average and σ Standard deviation,
$${G}_{σ} ( x , y ) = \frac{1}{2 {Πσ}^{2}} {ⅇ}^{\frac{{x}^{2} + {y}^{2}}{2 {σ}^{2}}}$$
α is the balance ratio and β is the space ratio;
i. smoothing all the channels of the original image (R₀,G₀,B₀) by convoluting it with an average operator, such as a gaussian smoother:
Im₂=G_{σ}_{₁}*Im₀;
j. contracting (or stretching) the contrast of the intensity channel of the smoothed image V₂=max(R₂, G₂, B₂) between predefined limits, by using percentage enhancement:
$$\{ \begin{matrix}if {K}_{1} < {V}_{2} ( x , y ) < {K}_{2 } then \\ {V}_{3} ( x , y ) = ( {V}_{2} ( x , y ) - {K}_{1} ) \cdot \frac{{M}_{2} - {M}_{1}}{{K}_{2} - {K}_{1}} + {M}_{1} \\ else if {V}_{2} ( x , y ) \geq {K}_{2} then \\ {V}_{3} ( x , y ) = {M}_{2} \\ else \\ {V}_{3} ( x , y ) = {M}_{1}\end{matrix}$$
where K₁ and K₂ are lower and upper limits, appropriately, in the intensity channel of the smoothed image, and M₁ and M₂ are lower and upper limits, appropriately, in the intensity channel of the contracted (stretched) image;
k. compensating the rest of the channels of Im₃ (x, y) for the contraction (or stretching) (d) by keeping the relations
$$\frac{{R}_{3}}{{G}_{3}} = \frac{{R}_{2}}{{G}_{2}} , \frac{{G}_{3}}{{B}_{3}} = \frac{{G}_{2}}{{B}_{2}} . ;$$
l. superimposing the two adjacent lines on the relevant edges and lines in the intensity channel of the contrast contracted (stretched) and smoothed image by using the following rule:
$$\{ \begin{matrix}if {V}_{1} ( x , y ) \geq A then \\ {V}_{4} ( x , y ) = 0 \\ else if {V}_{1} ( x , y ) \leq B then \\ {V}_{4} ( x , y ) = 255 \\ else \\ {V}_{4} ( x , y ) = {V}_{3} ( x , y )\end{matrix}$$
where A and B are the upper and lower thresholds; and
g) compensating the rest of the channels of Im₄ (x, y) for the superimposition
(f) by keeping the relations
$$\frac{{R}_{4}}{{G}_{4}} = \frac{{R}_{3}}{{G}_{3}} , \frac{{G}_{4}}{{B}_{4}} = \frac{{G}_{3}}{{B}_{3}} .$$

70. The method of claim 45 further including a size test for determining the quality of results comprising the further steps of:
e. presenting the image to a visually impaired with a size, which is below the recognition or perception threshold;
f. increase the image size gradually;
g. letting the visually impaired sign when he/she first identifies the object or perceive the feature in the image; and
h. ranking the quality of the image according to the identification or the perception size.

71. The method of claim 45 further including a contrast test for determining the quality of results comprising the further steps of:
e. presenting the image to the visually impaired with a contrast; which is below the recognition or perception threshold;
f. increasing the image contrast gradually;
g. letting the visually impaired to sign when he/she first identifies the object or perceive the feature in the image; and
h. ranking the quality of the image according to the identification or the perception contrast; and/or
a simulation test for determining the quality of results comprising the further steps of:
a. simulating damages and perceptual effects of visually impaired individual;
b. transforming an enhanced image according to the simulation;
c. transforming the original images according to the simulation;
d. ranking the quality according to comparison of the transformation results on the original and enhanced images.

72. A Psychophysical test for the damage of the visually impaired observer that uses the following steps:
a. testing the perceived uniformity of line grating with different spatial frequencies;
b. testing the perceived number of missing dots in a regular array of dots with different densities; and
c. testing the perceived uniformity of irregular array of dots with different irregularity levels.

73. Apparatus for image enhancement for visually impaired that substitutes relevant edges and lines of an image with two adjacent lines and diminishes the background of the image by utilizing an algorithm wherein
a. the intensity channel I₀ (x, y) of an image is captured Im₀(x, y);
b. the relevant edges and lines are signed by convoluting the intensity channel of the original image with Difference of Gaussian (DOG):
I₁=(G_{σ}_{₀}−α·G_{β·Γ}₀)*I₀
where G_{σ}(x, y) is a Gaussian function with zero average and σ Standard deviation,
$${G}_{σ} ( x , y ) = \frac{1}{2 {Πσ}^{2}} {ⅇ}^{\frac{{x}^{2} + {y}^{2}}{2 {σ}^{2}}}$$
α is the balance ratio and β is the space ratio;
c. all the channels of the original image are smoothing by convoluting it with an average operator, such as a gaussian smoother:
Im₂=G_{σ}_{₁}*Im₀;
d. the contrast of the intensity channel of the smoothed image is contracting (or stretching) between predefined limits, by using percentage enhancement:
$$\{ \begin{matrix}if {K}_{1} < {I}_{2} ( x , y ) < {K}_{2 } then \\ {I}_{3} ( x , y ) = ( {I}_{2} ( x , y ) - {K}_{1} ) \cdot \frac{{M}_{2} - {M}_{1}}{{K}_{2} - {K}_{1}} + {M}_{1} \\ else if {I}_{2} ( x , y ) \geq {K}_{2} then \\ {I}_{3} ( x , y ) = {M}_{2} \\ else \\ {I}_{3} ( x , y ) = {M}_{1}\end{matrix}$$
where K₁ and K₂ are lower and upper limits, appropriately, in the intensity channel of the smoothed image, and M₁ and M₂ are lower and upper limits, appropriately, in the intensity channel of the contracted (stretched) image;
k. the rest of the channels of Im₃ (x, y) are compensated for the contraction (or stretching);
l. the two adjacent lines on the relevant edges and lines in the intensity channel of the contrast contracted (stretched) and smoothed image are superimposed by using the following rule:
$$\{ \begin{matrix}if {I}_{1} ( x , y ) \geq A then \\ {I}_{4} ( x , y ) = 0 \\ else if {I}_{1} ( x , y ) \leq B then \\ {I}_{4} ( x , y ) = 255 \\ else \\ {I}_{4} ( x , y ) = {I}_{3} ( x , y )\end{matrix}$$
where A and B are the upper and lower thresholds; and
the rest of the channels of Im₄ (x, y) are compensated for the superimposition.

74. Apparatus for image enhancement for visually impaired that substitutes relevant edges and lines of an image with two adjacent lines and diminishes the background of an image by using HSV and RGB color image formats by utilizing an algorithm wherein
g. the intensity channel V₀ (x, y)=max(R₀,G₀, B₀) of the image. Im₀ (x, y) is captured;
h. the relevant edges and lines are signed by convoluting the intensity channel of the original image with Difference of Gaussian (DOG):
V₁=(G_{σ}_{₀}−α·G_{β·σ}_{₀})*V₀
where G_{σ}(x, y) is a Gaussian function with zero average and σ Standard deviation,
$${G}_{σ} ( x , y ) = \frac{1}{2 {Πσ}^{2}} {ⅇ}^{\frac{{x}^{2} + {y}^{2}}{2 {σ}^{2}}}$$
α is the balance ratio and β is the space ratio;
i. all the channels of the original image (R₀,G₀,B₀) are smoothed by convoluting it with an average operator, such as a gaussian smoother:
Im₂=G_{σ}_{₁}*Im₀;
j. the contrast of the intensity channel of the smoothed image V₂=max(R₂,G₂,B₂) is contracted (or stretched) between predefined limits, by using percentage enhancement:
$$\{ \begin{matrix}if {K}_{1} < {V}_{2} ( x , y ) < {K}_{2 } then \\ {V}_{3} ( x , y ) = ( {V}_{2} ( x , y ) - {K}_{1} ) \cdot \frac{{M}_{2} - {M}_{1}}{{K}_{2} - {K}_{1}} + {M}_{1} \\ else if {V}_{2} ( x , y ) \geq {K}_{2} then \\ {V}_{3} ( x , y ) = {M}_{2} \\ else \\ {V}_{3} ( x , y ) = {M}_{1}\end{matrix}$$
where K₁ and K₂ are lower and upper limits, appropriately, in the intensity channel of the smoothed image, and M₁ and M₂ are lower and upper limits in the intensity channel of the contracted (stretched) image;
k. the rest of the channels of Im₃ (x, y) are compensated for the contraction (or stretching) by keeping the relations
$$\frac{{R}_{3 }}{{G}_{3}} = \frac{{R}_{2}}{{G}_{2}} , \frac{{G}_{3}}{{B}_{3}} = \frac{{G}_{2}}{{B}_{2}} ;$$
l. the two adjacent lines on relevant edges and lines in the intensity channel of the contrast contracted (stretched) and smoothed image are superimposed by using the following rule:
$$\{ \begin{matrix}if {V}_{1} ( x , y ) \geq A then \\ {V}_{4} ( x , y ) = 0 \\ else if {V}_{1} ( x , y ) \leq B then \\ {V}_{4} ( x , y ) = 255 \\ else \\ {V}_{4} ( x , y ) = {V}_{3} ( x , y )\end{matrix}$$
where A and B are the upper and lower thresholds; and
g.) the rest of the channels of Im₄ (x, Y) are compensated for the superimposition by keeping the relations
$$\frac{{R}_{4}}{{G}_{4}} = \frac{{R}_{3}}{{G}_{3}} , \frac{{G}_{4}}{{B}_{4}} = \frac{{G}_{3}}{{B}_{3}} .$$

75. Apparatus according to claim 73 wherein the parameters of the system filters, transformation, operators, functionality, operation, and mode of operation are adjustable.

76. Apparatus according to claim 73 wherein the adjustment of the parameters influences the output image.

77. Apparatus according to claim 73 wherein the apparatus includes one of the following:
g. an input tuner that receives the video images in the input format and transceives them to base band;
h. an Analog to Digital transceiver that samples the video frames;
i. a computerized processor that modifies the sampled images;
j. a digital to Analog transceiver that integrates the frames to analog video stream;
k. an output mixer that transforms the base band video stream to the desired output format; and
l. control panel (local or remote) enabling to control running of parameters of the method, and tests.

78. Apparatus according to claim 73 that is housed in one of:
q. a “Set top” box at the input of a TV set or a VCR (VideoCassette Recorder)—local enhancement;
r. server of a TV (Television) content provider, such as the Cables or the Satellite stations (remote enhancement);
s. a Digital TV, such as High Definition TV;
t. Digital VCR player;
u. DVD (Digital Versatile Disc) player;
v. Close Circuit TV;
w. Personal Computer (PC) card;
x. Personal Computer package;
y. PDA (Personal Digital Assistant).
z. Handheld computer;
aa. Pocket PC;
bb. Multimedia Player;
cc. Computer card;
dd. Internet server;
ee. Chip set;
ff. an apparatus at the input of a head mounted display.

79. Apparatus according to claim 73 which is used for:
d. Improving the visual perception of visually impaired individual.
e. Improving of Infrared images for observer with normal vision.
f. Improving of Ultrasound images for observer with normal vision.
